(19) United States
(12) Patent Application Publication
(10) Pub. No.: US 2022/0134552 A1
(43) Pub. Date: May 5, 2022

(54) VIBRATION SUPPRESSION AND DYNAMIC BALANCING FOR RETARGETING MOTIONS ONTO ROBOTIC SYSTEMS

(71) Applicant: DISNEY ENTERPRISES, INC., Burbank, CA (US)

(72) Inventors: Moritz Niklaus Bächer, Zurich (CH); Lars Espen Knoop, Zurich (CH); Christian Gabriel Schumacher, Aarau (CH)

(21) Appl. No.: 17/574,031

(22) Filed: Jan. 12, 2022

Related U.S. Application Data
(63) Continuation-in-part of application No. 16/451,209, filed on Jun. 25, 2019.
Application No. 16/451,209 is a continuation-in-part of application No. 17/124,351, filed on Dec. 16, 2020.

(51) Int. Cl. B25J 9/16

(52) U.S. Cl. CPC B25J 9/1633

(57) ABSTRACT

A system providing dynamic balancing in a robotic system. The system includes memory storing a definition of a robot and storing an input animation for the robot specifying motion of components of the robot. A simulator performs a dynamic simulation of the robot performing the input animation including modeling a first set of the components as flexible components and a second set of the components as rigid components. Each of the flexible components is coupled at opposite ends to one of the rigid components. An optimizer generates a retargeted motion for the components to provide dynamic balancing of the robot performing the retargeted motion. The optimizer generates the retargeted motion by transforming forces acting on the robot to a local contact frame rigidly moving with the robot. The optimizer generates the retargeted motion so a zero-moment point of the robot lies in a support area of the robot's feet.

### CROSS REFERENCE TO RELATED APPLICATIONS

This application is a continuation-in-part (CIP) of U.S. patent application Ser. No. 16/451,209, filed Jun. 25, 2019, which is incorporated herein by reference in its entirety.

### BACKGROUND

### 1. Field of the Description

The present description relates, in general, to robots (or “robotic systems” or “robotic characters”) and control systems and methods for such robots. More particularly, the description relates to a method of generating control signals for a robotic system or robot (and to controllers implementing such a method and robotic systems or robots with such controllers) that provides computational vibration suppression with or without dynamic balancing during the movements of the robotic system or robot.

### 2. Relevant Background

Audio-animatronic figures and other robotic systems often suffer from unwanted vibrations during their operations. In particular, robotic systems or robots often will experience undesirable vibrations when undergoing fast and dynamic motions such as may be useful in a robotic character to provide expressive animations. For example, a robot may have an arm or leg that they move quickly from one location to a second location to provide a desired movement or move to a new pose, and the robot's arm or leg may vibrate significantly upon stopping at the second location. This can be undesirable when trying to replicate a particular character's movements, when trying to provide human-like motions, and so on.

In general, robotic systems are designed to be as stiff as possible, but, unfortunately, the physical system is rarely sufficiently stiff to behave like an idealized mechanical system whose components are assumed to be perfectly rigid. Hence, in real, implemented robotic systems, the unwanted vibrations will arise from compliance and deformation in both the joints and the components of the robotic system. This makes the task of animating the physical system a very challenging and tedious endeavor. In an ideal design world, the robot designers could rig a robotic character, have a skilled animator provide realistic, plausible, and natural-looking animations cycles, and then replay these animations directly on the physical system (i.e., the robot whose control is being designed). In reality, though, these animations may often lead to unwanted vibrations, which forces the designer to manually tune the motion trajectories (e.g., slow the movements down) while running experiments on the physical robot in order to try to avoid the vibrations.

Hence, there remains a need for a new method of generating control signals (and a new robot controller implementing such methods and robots/robotic systems with such controllers) to control operations of a robotic system so as to reduce (or even eliminate in some cases) unwanted vibrations of the robotic system components such as during rapid movements.

### SUMMARY

With the above vibration issues in mind, a robot control method (and associated robot controllers and robots operating with such methods and controllers) is described herein that provides computational vibration suppression. In some embodiments, the techniques described herein are performed offline in a design stage for a controller defining control signals (or trajectories set by such control signals). Given a desired animation cycle for a robotic system or robot, the control method (or its vibration suppression routine or controller module) uses a dynamic simulation of the physical robot. This simulation, which takes into account the flexible components of the robot, is adapted to predict if vibrations will be seen in the physical robot or robotic system. If vibrations are predicted to be present with the input animation cycle, the control method optimizes the set of motor trajectories to return a set of trajectories that are as close as possible to the artistic or original intent of the provider of the animation cycle, while minimizing unwanted vibration. Designing for stiffness leads to robotic systems that tend to be heavy, which requires strong and expensive motors to drive them. In contrast, the new control method/design tool that suppresses unwanted vibrations allows a robot designer to use lighter and/or softer (less stiff) and, therefore, less expensive systems in new robots. In other words, the new design/control method shifts design complexity toward computation.

The computational framework developed by the inventors takes as input animations (e.g., artist-specification of an animation that defines time-varying angles for motors or the like). The computational framework changes the animations, e.g., the time-varying motor angles, to minimize (or at least reduce) the difference between simulated and target trajectories of a set of user-selected (or controller selected) points on mechanical components such as the hands, feet, and/or joints of a robotic system. To be able to predict vibrations, the components of the robot are modeled as flexible bodies, such as by discretizing them with finite elements, and the dynamic behavior of the flexible bodies are then simulated while replaying target animations. The flexible bodies are coupled to rigid bodies at either end and then simulated as part of a multibody dynamics formulation. To estimate damping and stiffness parameters of components, motion-tracking markers are placed on the physical system, and parameters are tuned to make the simulations closely match the behavior of the physical systems.

The inventors recognized that the state of a dynamical system at a particular timestep is dependent on the states of all previous timesteps. Hence, to compare simulated trajectories to target trajectories, a full animation cycle should be simulated to be able to compare the performance to creative targets. To reduce time complexity in simulations, a reduced model may be used for FEM simulations of components. To computationally suppress vibrations, the difference between simulated and target trajectories is compared for a set of user-selected (or controller selected) points on the robotic system. Then, taking the entire motion trajectory into account, the motion profiles of the motors (time varying angles or the like) is optimized to reduce the visible vibrations.

The approach taught herein for a new robotic controller (or design of control signals for a robotic system) was tested on very soft (lower stiffness) systems of increasing complexity. While smaller in size than many animatronic devices, thin rod-like components in experimental setups were useful in generating very soft robotic systems that can be translated into design of larger robots. The testing showed that the new computational technique is very effective in suppressing vibrations while staying close to the input trajectories (e.g., artist-provided animations defining trajectories).

More particularly, a system is provided for suppressing vibration in a robotic system. The system includes memory (e.g., any useful data storage device) storing a definition of a robot defining a plurality of components of the robot and storing an input animation for the robot defining motion of the components of the robot over a time period. The system also includes a processor (which may include one or more processing devices) communicatively linked to the memory (in a wired or wireless manner allowing communication of digital data). The system further includes a simulator provided by the processor running software (or executing code or instructions in onboard RAM or the like). During operations of the system, the simulator performs a dynamic simulation of the robot performing the input animation including modeling a first set of the components as flexible components (or bodies) and a second set of the components as rigid components (or bodies). Each of the flexible components is coupled at opposite ends to one of the rigid components, and the dynamic simulation predicts vibrations for the robot in performing the defined motion. The system further includes an optimizer provided by the processor running software (e.g., executing instructions or code in RAM or the like). The optimizer generates a retargeted motion for the components by adjusting the defined motion to suppress a portion of the vibrations.

In some embodiments of the system, the portion of the vibrations that is suppressed is low-frequency, large-amplitude vibrations of one or more of the components of the robot. In these and other embodiments, the ends of the flexible components are coupled to the rigid components using constraint-based, two-way coupling. Further, the input animation may include a set of motor trajectories, and, in such cases, the optimizer modifies the set of motor trajectories to generate the retargeted motion for the components. Additionally, the memory may store a set of user-selected points on the components of the robot, and the optimizer may modify the set of motor trajectories to retain trajectories of the user-selected points from the defined motion in the retargeted motion. In some cases, the set of user-selected points are on end effectors or rigid bodies of the robot.

In some preferred implementations of the system, the optimizer generates the retargeted motion by minimizing differences between locations of a set of tracked marker points attached to rigid bodies in the components of the robot in the defined motion and in the retargeted motion and by allowing vibrations in one or more of the components disposed between the set of rigid bodies. In such implementations, the minimization of differences is adapted to allow some amount of overshooting of target locations of the set of tracked marker points to reduce global error regarding relative positioning of the set of tracked marker points during the retargeted motion, by minimizing the error integrated over time.

In some cases, the components of the robot include tracked marker points, and the generating of the retargeted motion includes retaining orientations of the tracked marker points in orientations in the defined motion of the input animation. In these and other cases, the generating of the retargeted motion includes retaining relative positions in global coordinates of pairs of neighboring ones of the rigid components. If the global coordinates of rigid bodies adjacent to a deformable body are tracked, the accumulation of vibrations in deformable components can be controlled. Additionally, the system may include a robot controller including the processor, and the robot controller is adapted to generate a set of control signals for a physical implementation of the robot (e.g., to control the physical robot) based on the retargeted motion generated by the optimizer.

In some applications, it may be useful to further provide robot control to achieve dynamic balancing of a bipedal or other robot during free walking (or anchored) movements. The dynamic balancing control may utilize portions of the simulation and modeling techniques used for vibration suppression and/or may be combined with such techniques to provide retargeted motions that provide dynamic balancing and/or vibration suppression as may be useful for particular robot system implementations. Dynamic balancing can reduce the required motor torques and suppress visible vibrations.

In this aspect of the description, a system is described for providing dynamic balancing in a robotic system. The system includes memory storing a definition of a robot defining a plurality of components of the robot and storing an input animation for the robot specifying motion of the components of the robot over a time period. The system further includes a processor communicatively linked to the memory and a simulator provided by the processor running software. The simulator performs a dynamic simulation of the robot performing the input animation including modeling a first set of the components as flexible components and a second set of the components as rigid components. Typically, each of the flexible components is coupled at opposite ends to one of the rigid components. Further, the system includes an optimizer provided by the processor running software, and, significantly, the optimizer generates a retargeted motion for the components to provide dynamic balancing of the robot while performing the retargeted motion.

In some implementations of the system, the optimizer generates the retargeted motion, in part, by transforming forces and torques acting from an environment in which the robot is positioned onto the robot to a local contact frame rigidly moving with the robot. In these or other implementations, the optimizer generates the retargeted motion such that a zero-moment point of the robot lies in a support area of one or more feet or other effector components of the robot contacting an environmental surface. It may also be desirable that the optimizer generates the retargeted motion such that the normal force on the foot or other effector component is non-negative, such that forces applied to the robot from the environmental surface lie in a friction cone, and such that a moment about the vertical axis of the foot or other effector component is bounded from above and below. To this end, instead of using constraints, the optimizer can be programmed to generate the retargeted motion using objectives formulated to retain the zero-moment point a minimum distance from a boundary of the support area.

According to other aspects of the dynamic balancing and vibration suppression description, a system is taught for controlling a robotic system with dynamic balancing. The system includes memory storing parameters of a target robotic system and an input motion for the target robotic system, and the input motion is defined by a set of motor trajectories defining movement of components of the robotic system. The system further includes an optimizer modifying the set of motor trajectories to provide dynamic balancing of the robotic system during operations to perform a retargeted motion based on the input motion. The modifying step can include transforming forces and torques acting on the robot to a local contact frame rigidly moving with the robot.

In some cases, the modifying step can also involve generating the retargeted motion such that the transformed forces lie in a friction cone. In these or other cases, the modifying step can include generating the retargeted motion such that a zero-moment point of the robot lies in a support area of one or more feet or other effector components of the robot contacting the ground or a support surface. Still further, the modifying step can include generating the retargeted motion such that the normal force on the foot or other effector component is non-negative and a moment about the vertical axis of the foot or other effector component is bounded from above and below. To this end, instead of using constraints, the optimizer can be programmed to generate the retargeted motion using objectives formulated to retain the zero-moment point a minimum distance from a boundary of the support area.

In some exemplary implementations of the system, the system will include a differential dynamics simulator generating a simulation of the input motion by modeling the target robotic system by representing flexible parts of the components with deformable bodies and stiff parts of the components with rigid bodies and by enforcing two-way coupling constraints between ends of the deformable bodies coupled to the rigid bodies. In such implementations, the simulation can include enforcing mechanical constraints between coupled pairs of the rigid bodies, and the enforcing of the mechanical constraints and the two-coupling constraints can be performed using a unified constrained dynamics model.

The system may build upon the vibration suppression technology with the ends of the flexible components being coupled to the rigid components using constraint-based, two-way coupling. Also, the optimizer can be programmed to generate the retargeted motion by adjusting the defined motion to suppress a portion of the vibrations, and the portion of the vibration that is suppressed can include low-frequency, large-amplitude vibrations of one or more of the components of the robot. Further, the components can include marker points, and the generating of the retargeted motion can involve retaining orientations of the marker points as defined in the specified motion of the input animation and also involve retaining positions of tracked marker points or a tracked set of the rigid components in global coordinates relative to the input animation. To implement the system, it may further include a robot controller including the processor, and the robot controller can be programmed to generate a set of control signals for a physical implementation of the robot based on the retargeted motion generated by the optimizer.

In other aspects of the description, a method is provided of suppressing vibration in a robotic system. The method includes receiving a set of input motions for a robot and then simulating the robot operating based on the set of input motions by representing, during replaying of the set of input motions, flexible components of the robot as deformable bodies and rigid components of the robot as rigid bodies and by enforcing two-way coupling constraints between ends of the deformable bodies and the rigid bodies. The method further includes optimizing the set of input motions to generate a retargeted motion for the components of the robot that provides dynamic balancing of the robot. The optimizing can include computing the retargeted motion to provide a zero-moment point of the robot that lies in a support area of a foot or other effector component of the robot during the simulating.

In some examples of the method, the optimizing includes computing the retargeted motion by transforming forces and torques acting from an environment in which the robot is positioned onto the robot to a local contact frame rigidly moving with the robot, by requiring that the normal force on the foot or other effector component is non-negative, by requiring that the transformed forces lie in a friction cone, and by requiring that a moment about the vertical axis of the foot or other effector component is bounded from above and below. In these or other examples of the method, the optimizing includes optimizing the set of input motions to generate the retargeted motion for the components of the robot that suppresses the low-frequency vibrations, comparing differences between trajectories for a set of user-selected points on the rigid components during the replaying of the set of input motions and target trajectories for the set of user-selected points defined by the set of input motions, and optimizing, based on the comparing, motion profiles of motors of the robot to reduce visible vibrations in the robot.

### BRIEF DESCRIPTION OF THE DRAWINGS

FIG. 1 illustrates sequence of robotic motions/movements carried out by a robot/robotic system using retargeted animations and/or optimized motor trajectories generated by a computational method of the present description to suppress unwanted vibrations;

FIG. 2 illustrates a side perspective view of representation of a physical robot with deformable and rigid bodies in place of flexible and stiff parts of a robot's components;

FIG. 3 illustrates a graphic or schematic of the process of coupling deformable to rigid bodies used in the computation method of the present description;

FIG. 4 illustrates a graphic or schematic of relative coordinate formulation used in the computational method to discretize deformable parts of components relative to one of the coupled rigid bodies;

FIG. 5 provides graphs of displacement magnitude versus end effector first appearance; use Center of Mass (COM) during material fitting of a testing process carried out by the inventors for the vibration-minimizing techniques of the present description;

FIG. 6 are graphs showing use of linear modes and modal derivatives and applying the mass-Principal Component Analysis (PCA) basis reduced from full Boxer simulation data to one exemplary robotic character motion;

FIG. 7 illustrates results of testing of a single motor single rod robotic system using the vibration-minimizing technique discussed herein.

FIG. 8 illustrates results of testing of a single motor two rod robotic system similar to FIG. 7;

FIG. 9 illustrates results of testing of a dancer robotic system similar to FIGS. 7 and 8;

FIG. 10 illustrates results of testing of a bartender robotic system similar to FIGS. 7-9;

FIG. 11 illustrates results of testing of a rapper's arm robotic system similar to FIGS. 7-10;

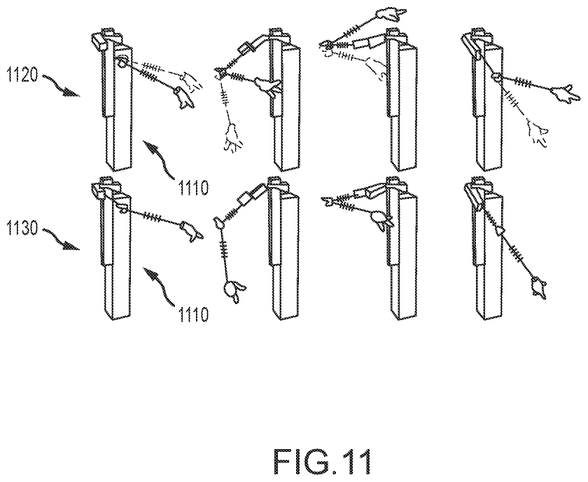

FIG. 12 illustrates results of testing of a drummer robotic system similar to FIGS. 7-11;

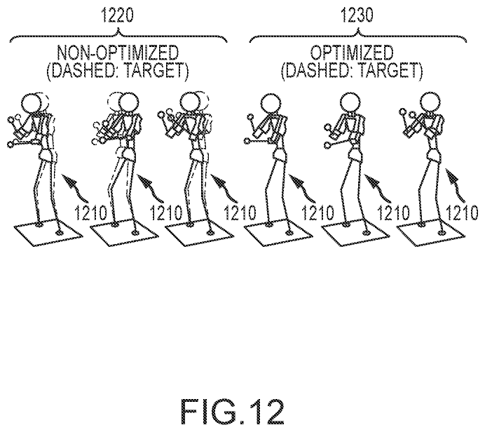

FIG. 13 illustrates results of testing of a boxing robotic system similar to FIGS. 7-12;

FIG. 14 is a graph illustrating setting of weights for a bipedal robot in a simulation representation for dynamic balancing;

FIG. 15 is a schematic illustration of a contact frame definition for use in optimization in dynamic balancing;

FIG. 16 illustrates graphs representing the optimization step of transforming forces and torques that act from the ground onto the rigid body to the contact frame defined with reference to FIG. 15; and

FIG. 17 illustrates graphically zero-moment computations performed during optimization for to provide dynamic balancing.

### DETAILED DESCRIPTION

Briefly, a method is described for generating vibration-minimizing motion or animation for robotic systems (or robots or robotic characters, herein). The retargeted motion generated from an input or target animation (or set of time-varying angles for motors or trajectories) may be created offline as a part of a controller design process and/or online by the controller using the techniques herein. The following discussion will begin with a brief overview of the new motion retargeting process and introduction to the design problem, and this will then be followed by a detailed discussion of specific implementations and testing in design of robotic characters. The inventors further recognized that dynamic balancing can be useful to further suppress vibration or otherwise more effectively control robotic systems, and, after the description of vibration suppression, methods and systems for providing dynamic balancing during control of robotic systems will be described as an extension of vibration suppression (e.g., with a controller providing both forms of control) or as a standalone control process (e.g., with a controller providing dynamic balancing with or without use of the vibration control processes presented below).

Creating animations for robotic characters is very challenging due to the constraints imposed by their physical nature. In particular, the combination of fast motions and unavoidable structural deformations leads to mechanical oscillations that negatively affect their performances. One goal of the inventors is to automatically transfer motions created using traditional animation software to physical robotic characters while avoiding such artifacts. To this end, the inventors developed an optimization-based, dynamics-aware motion retargeting method and system that adjusts an input motion such that visually salient low-frequency, large-amplitude vibrations are suppressed. A technical core of the new method and system (which may be labeled an animation system/method) includes a differentiable dynamics simulator that provides constraint-based, two-way coupling between rigid and flexible components. The efficacy of the new method was demonstrated through experiments performed on a total of five robotic characters including a child-sized animatronic figure that featured highly dynamic drumming and boxing motions.

As background to the new system/method, it should be understood that ever since Leonardo da Vinci's time, children and adults alike have been fascinated by mechanical systems that are designed to generate natural movements. Over the centuries, da Vinci's first automatons—the Mechanical Lion and the Knight have evolved into lifelike animatronic figures that are routinely deployed in museums, theme parks, and movie studios across the world. Today, in part due to the advent of affordable, easy-to-use digital fabrication technologies and electromechanical components, the process of creating compelling robotic characters is easily accessible to anyone.

Keyframing techniques are commonly used to breathe life into animatronic characters. While these techniques are conceptually identical to those employed in computer animation, creating vibrant motions for real-world characters introduces unique challenges. These challenges stem from the physical characteristics of an animatronic figure's (or robotic system's) design. It is easy, for example, to design virtual characters that have as many degrees of freedom as needed. The design of their robotic counterparts, on the other hand, involves balancing motion versatility against the constraints imposed by the size, weight, and placement of its mechanical components. Furthermore, the motions of real-world characters are strictly bound to the laws of physics. While the idealized limbs of a virtual character are perfectly rigid, for example, structural deformations are unavoidable in physical systems. Unfortunately, the combination of dynamic motions, weighty components, and structural deformations leads to large-scale vibrations during robot movements matching those of the virtual world character. These mechanical oscillations are due to the cyclic transfer between kinetic and potential deformation energy, and they can negatively impact the robot character's performance of the input/target animations.

To combat vibrations, mechanical structures are typically engineered to be as stiff as possible. While such designs work well in industrial settings, these robots are heavy and bulky such that they are ill-suited for many types of robotic characters. An alternative design is to control the robot so as to slow down the motions that are performed to the point where they approach the quasi-static regime. This, of course, is also undesirable when trying to provide a robot that performs similar to a known character (e.g., repeat motions of a human character from a movie or the like). Animators are, therefore, left (before the present invention) with only one option: endlessly tweaking motions in a painstaking, trial-and-error workflow. A goal of the inventors in creating the new motion (or robotic control) method is to fundamentally rethink this process through a physics-based motion retargeting method that is tailored for physical robots and characters provided by such robots' movements.

A novel approach is described herein for creating compelling motions for real-world characters. The input to the method includes motions that are authored using standard animation software such as Autodesk's Maya. Leveraging a simulation model that balances speed and accuracy, the computational method generates an optimized motion that deviates from the input as little as possible while minimizing displeasing artifacts that arise from structural vibrations. The efficacy of the new method is demonstrated through a variety of lightweight physical robots that generate complex motions. The new method provides at least the following new and useful aspects/steps: (a) dynamics-aware motion retargeting for physical robotic characters; (b) continuous space-time optimization for computationally suppressing structural vibrations; and (c) a general formulation of constrained multibody dynamics with two-way coupling between rigid and elastic components.

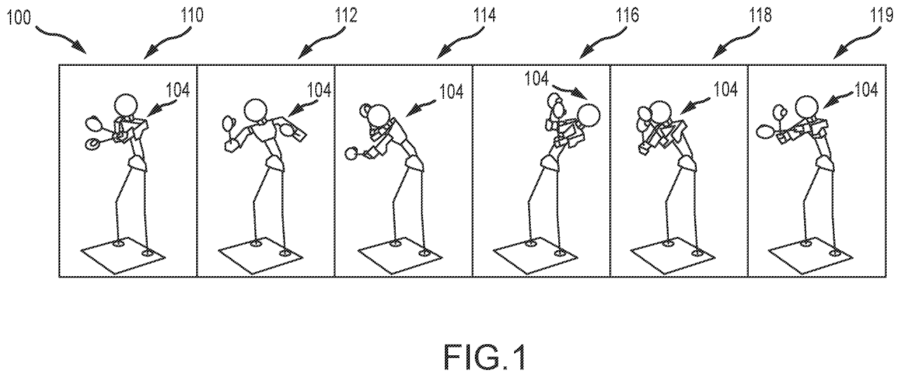

Evaluation of these aspects and the new method/system is achieved through lively animations that are retargeted to complex robotic characters. For example, FIG. 1 shows animation 100 of a robotic system or robot 104 having a torso, a head, and wire/rod arms and legs to provide a character in the form of a boxer. FIG. 1 shows the animation (or boxing sequence) 100 that is made up of a series of movements 110, 112, 114, 116, 118, and 119 that provides fast punches, blocks, and dodges by the robot 104 using control signals generated using the retargeted animation (or motor trajectories) output by the new computational method for use by a robot controller (i.e., a controller operating the robot 104). As shown with movements 110-119, the new method retargets fast and dynamic animations onto the physical robotic character 104, where the motor trajectories are optimized in order to suppress unwanted structural vibrations and to match the artistic intent as closely as possible.

As an overview of the computational method, given an animation sequence (e.g., input animation provided by an artist or the like), a goal for the computational method is to retarget the motion onto a physical robotic character while avoiding undesirable vibrations due to system dynamics. The motor angles could be extracted from the input animation sequence and replayed on the physical robot, but this may often lead to substantial unwanted vibrations, e.g., due to unavoidable compliance in the components of the physical robot. This can cause the physical robot to deviate significantly from the target or input animation sequence (e.g., the boxing robot 104 of FIG. 1 may have their gloved hands at the end of the rapidly moving arms swing back and forth in a pendulum manner at the end of each of the motions 110-119). To address this problem a computational tool is provided that optimizes the motor trajectories in order to suppress vibrations while matching the intended or input animation as closely as possible.

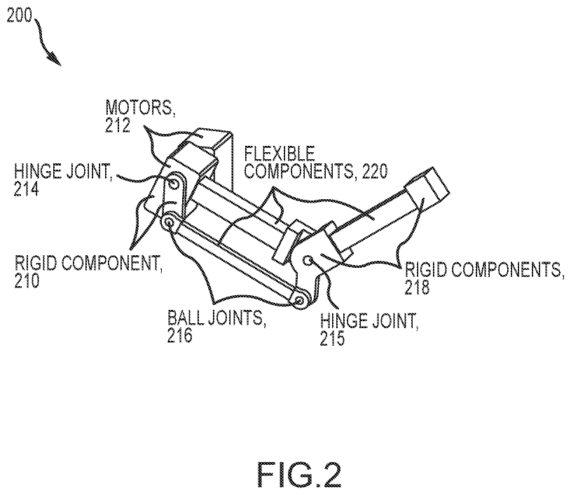

The robotic character, for the computation model, is assumed to be a multi-body system including both rigid components (such as mechanical joints and motors) and flexible bodies that will deform under dynamic motions. FIG. 2 shows a robotic system (or subsystem of a robot or robotic character) 200 that includes rigid components 210 in the form of motors 212, hinge joints 214, 215, ball joints 216, and end members/effectors 216 and flexible components 220 (e.g., elongated links and the like). To simulate the dynamic behavior of robotic characters, flexible parts of components of the robot 200 are represented using deformable bodies and sufficiently stiff parts/components of the robot 200 are represented using rigid bodies. To enforce two-way coupling constraints between deformable and rigid bodies (such as between one of the flexible components 220 and the motors 212 or end members 216), a unified constrained dynamics model is formulated. The computational method can support assemblies with loops and components with a wide range of geometries, mass, and stiffness with the robot 200 being only a simplified example of a useful model of a physical robot (or a portion of such a robot).

As shown with robot 200 of FIG. 2, rigid components are connected to each other using mechanical joints, and flexible bodies are coupled to adjacent rigid components. To physically simulate the dynamics of the system, all sub-systems are time-stepped together in a unified integration scheme, while accurately modeling the two-way coupling effects between subsystems. The deformations on flexible bodies are moderate when observed from the coupled rigid body. By exploiting this, fast and accurate simulation of the robotic character is achieved via modal reduction techniques.

In the following, the constituent elements of the simulation are first described including elastodynamics, rigid body dynamics, and constraints. Then, a unified integration scheme is presented for dynamics simulation. Next, fast subspace simulation of the robotic characters is presented, with a detailed explanation of how the rigid-body dynamics are integrated in global coordinates while the reduced deformable simulation is solved in the local frame of the coupled rigid body. This is followed by a discussion of using a dynamics simulator to formulate a space-time optimization on motor controls in order to suppress vibrations using a continuous adjoint method. Finally, the description turns to validation of the simulation model by presenting two simple and illustrative examples and to demonstrate the efficacy of the optimization method by retargeting five rich motions to complex physical robotic characters or robots.

With regard to constrained dynamics, to simulate physical robotic characters (as shown with robot 200 of FIG. 2), the inventors use an elastodynamics model to represent flexible parts of the robot's components and rigid bodies to represent parts with a high enough stiffness. The rigid bodies, in turn, are connected to one another with either mechanical joints such as hinges, ball-and-socket connectors, or the like, or with standard rotational motors.

With regard to elastodynamics, the motion of a 3D point x(X,t) on a deformable body, located at the reference location X at time t₀, is governed by the equations of motion as follows:

ρ(X,t)−∇·P^{T}(X,t)−μg=0 Eq. (1)

where the density ρ may vary within the reference domain Ω. Integrated over Ω, the divergence of the transposed first Piola-Kirchhoff stress tensor P results in internal elastic forces that counteract inertia and gravity g (note, g is a 3D vector pointing in the direction of gravity, and its magnitude is the gravitational acceleration).

Spatially discretizing the components with finite elements and interpolating their nodal displacements with quadratic Lagrange shape functions, the standard first-order ODE may be formed as:

\dot{u}=v and M\dot{v}=f(u,v) Eq. (2)

where u, v∈ [symbol] collect the displacements and velocities of the n nodal degrees of freedom. The forces f=−f_{damp}−fᵢₙₜ+fₑₓₜ combine internal forces fᵢₙₜ, external forces Tₑₓₜ that are set to gravity, and Rayleigh damping f_{damp} (u, \dot{u})=(αM+βK(u)) with mass matrix M and tangent stiffness K. The inventors relied on the Neo-Hookean model for accurate nonlinear stress evaluations since the robotic components undergo large rotations and deformations are moderate even with the relative coordinate formulation (described below). Above, quantities are underlined for which the same standard letters are common in rigid body dynamics (where they overlined).

With regard to rigid body dynamics, to transform points in a body to global coordinates, one can characterize states of bodies with their orientation R(t) and position c(t). Columns of rotations R represent a body's frame axes [rₓ, r_{y}, r_{z}], and the position of its center of mass c is represented by the frame center at time t. The state of a body is governed by the first-order ODE form of the Newton-Fuler equations, as:

$$[ \begin{matrix}\dot{c} \\ \dot{q}\end{matrix} ] = [ \begin{matrix}w \\ Q ω\end{matrix} ] and [ \begin{matrix}\overline{M} & \\ & {I}_{c}\end{matrix} ] [ \begin{matrix}\dot{w} \\ \dot{ω}\end{matrix} ] = [ \begin{matrix}\overline{f} \\ {τ}_{c} - {[ ω ]}_{x} {I}_{c} ω\end{matrix} ] \qquad Eq . ( 3 )$$

where w is the linear and ω the angular velocity, M̅ the mass, and I_{c}=RI_{rb} R^{T} the moment of inertia of the body, with I_{rb} referring to the constant angular mass in body coordinates. To reduce required normalization, the inventor represents rotations with quaternions and use the 4×3-transformation matrix Q(q). The net force f̅ acting on the body includes gravity, and, for the sake of brevity, one can absorb the term [ω]ₓI_{c}ω in the net torque τ_{c} in what follows. [ω]ₓ is the matrix form of the cross-product with ω.

With regard to constraints, the inventors include two types of constraints in their dynamic system: (1) mechanical joints that couple rigid bodies pairwise and (2) interfaces between deformable and rigid bodies where degrees of freedom of the finite elements simulation mesh are moving as-rigidly-as-possible with the attached bodies.

As to mechanical joints, to formulate constraints between pairs of rigid bodies, rigid frames are attached to either body, and they are then transformed with their respective orientations and positions. Asking their centers or axes to coincide or remain orthogonal to one another, constraints can be formulated as:

C(t,c(t),q(t))=0 Eq. (4)

that depend on the orientations and positions of the bodies due to these transformations. For motors, the inventors actively changed the relative positions of the two frames so that there was a direct dependence on t.

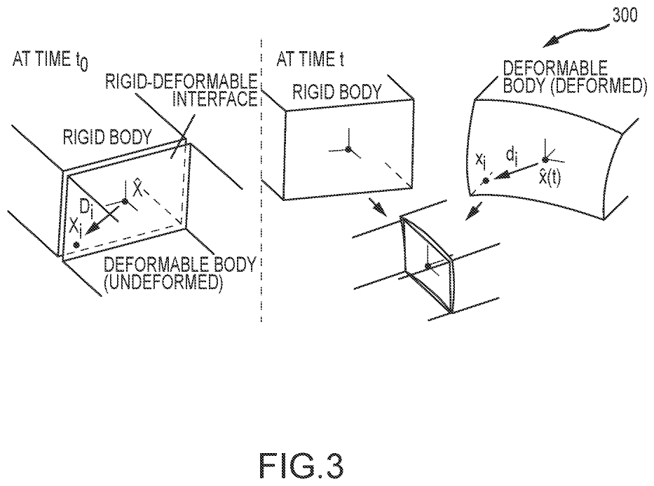

To couple deformable bodies to rigid bodies, a similar mechanism may be used that involves asking frames on either body to coincide in global coordinates. FIG. 3 illustrates with graphic 300 coupling deformable bodies to rigid bodies. A frame on either body can be defined, asking their centers and axes to be equal at time t. To define a center on the rigid body, one can extract the “centroid” \hat{X} of the area-weighted interface nodes Xᵢ at t₀, transforming its location to rigid body coordinates. At time t, one can then ask the transformed center to equal the “centroid” of the deformed interface nodes \hat{x}(t). To extract the rotation between the undeformed and deformed interface, one can compute the transformation that maps vectors Dᵢ=Xᵢ−\hat{X} to their deformed configuration dᵢ=xᵢ−\hat{x}. Then the orientation of the frame on the rigid body can be set to equal the rotational part of this transformation.

However, because interface nodes on the deformable body do not remain rigid, the formulation of coupling constraints is more involved. The inventors did not assume the input assemblies to be hierarchical. Due to loops in the robotic character assemblies, deformable bodies can be coupled to more than one rigid body (e.g., as in the robotic system 200 of FIG. 2). Moreover, rather than with a penalty method, the inventors enforce coupling in their new computational method with constraints, which constitutes a more physically accurate model besides enabling the stable integration without the necessity of a tedious parameter tuning.

In a first step, the frame centers on either body are extracted that are desired to coincide throughout the motion. To this end, the area-weighted average \hat{X} and \hat{x}(t) of nodes on the interface are computed at rest and time t, respectively. The two “centroids” are then caused to coincide in the local frame of the rigid body with:

R(t₀)^{T}(\hat{X}−c(t₀))−R(t)^{T}(\hat{x}(t)−c(t))=0 Eq. (5)

To constrain the relative orientations of the two bodies, the optimal linear transformation A(t) is first found that transforms difference vectors Dᵢ=Xᵢ−\hat{X} to their deformed configuration dᵢ (t)=xᵢ (t)−\hat{x}(t) by minimizing the sum of squared differences Σᵢ ŵᵢ(ADᵢ−dᵢ)², weighted with the normalized interface area incident to node i. Then, the orientations of the interface on the deformable and rigid body are set to coincide with:

R(t)R(t₀)^{T}−(PD(A(t))=0 Eq. (6)

where the polar decomposition (operator PD) is used to extract the rotational part of the transformation A. To minimize the number of constraints, the orthogonality can be enforced between columns of the combined rotation R(t)R(t₀)^{T} and the axes of the rotational part of A with three dot product constraints. Because the deformed nodes on the interface depend on the displacement, the combined constraints are:

C(t,c(t),q(t),u(t))=0 Eq. (7)

and depend on u besides the rigid body locations and orientations.

With regard to enforcing constraints, the computational method includes formed constraint Jacobians C_{c}, C_{q}, and Cᵤ with regards to locations and orientations of rigid bodies and displacements of the deformable bodies. The constraint forces C_{c}^{T} Λ and Cᵤ^{T} Λ are added to f̅ and f, respectively. A is a vector of Lagrange multipliers (one per constraint). Note that constraint torques (C_{q}Q)^{T} require a transformation with matrix Q before they are added to Tc. By construction, these generalized forces do not do any work on the system. Hence, they do not add nor remove energy. To form Jacobians of the coupling constraints, the derivatives of the polar decomposition are taken (with derivations of the first and second derivative of operator PD being known in the arts). While only the first derivatives are needed for simulation, second derivatives are used for gradient computations during optimization as discussed below.

To form the system of differential-algebraic equations (DAE) that describe the dynamics of the robotic characters, the inventors combined the deformable and rigid body ODEs (Eqs. (2) and (3)) as follows:

\dot{U}−TV=0 with T(U)=diag(E,Q(q),E) Eq. (8)

M\dot{V}−F−(C_{U}T)^{T}Λ=0 with M(U)=diag(M̅,I_{c}(q),M̅) Eq. (9)

with the algebraic equations C=0 in one unified system. In the above equations, the positions and orientations of the rigid and the displacements of the deformable bodies are collected in a generalized position vector U=[c q u]^{T}, and corresponding velocities are collected in a generalized velocity vector V=[w ω v]^{T}. Transformation matrix T relates velocities to the time derivatives of positions, and mass matrix M relates accelerations to generalized F(U, V)=[f̅ τ_{c}(c, q, ω) f(u, v)]^{T} and constraint forces (C_{U} T)^{T}. The torque not only depends on the locations but also the orientations and angular velocities because the torques [ω]ₓI_{c}ω were considered to be part of τ_{c}. Matrices E are identities of appropriate but different sizes.

Considering time discretization, it will be understood that a direct time integration of the above DAEs is not possible. This is because the constraints C=0 do not directly depend on velocities such that a discretization with neither an explicit nor an implicit scheme would lead to a solvable system. To enforce the constraints, one can either use the first or second time derivatives Ċ=0 or \ddot{C}=0, respectively. The use of the second time derivative results in a semi-explicit, index-1 DAE that can be discretized and solved with either an explicit or implicit scheme. However, because the components of the robotic system are flexible but very stiff, RK4 is unstable even if one were only to time-step the nonlinear deformable body ODE (see supplemental material at the end of this description). Hence, an explicit scheme is not an option. Instead, the inventors relied on velocity constraints Ċ+αC=0, α>0 where they added Baumgarte stabilization to avoid numerical drift in positions, resulting in the pure, index-2 DAE of:

$$G = [ \begin{matrix}E & \\ & M - {( {C}_{U} T )}^{T}\end{matrix} ] [ \begin{matrix}\dot{U} \\ \dot{V} \\ Λ\end{matrix} ] = [ \begin{matrix}TV \\ F \\ - {C}_{t} - {C}_{U} TV - α C\end{matrix} ] = 0 \qquad Eq . ( 10 )$$

that can only be directly discretized and solved with an implicit scheme. This is because the constraint is independent of the algebraic variables Λ. Due to the dependence of the motor angle on time t, the partial time derivative of the constraints, Cₜ, is non-zero for constraints that involve motors.

While a BDF discretization of either the semi-implicit, index-1 or the pure, index-2 DAE is stable and would fulfill the inventors' requirements for the computational method, some preferred embodiments may use the index-2 DAE because it avoids second derivatives of the constraints for simulation and third derivatives for gradient computations for the optimization. The latter are tedious to derive and implement due to the polar decompositions in the coupling constraints.

To avoid numerical damping, the nonlinear system of DAEs, G(t, S(t), \dot{S}(0)=0, was discretized, with state vector S=[U V Λ]^{T} and its time derivative \dot{S}=[\dot{U} \dot{V} \dot{Λ}]^{T}, with a BDF-2 scheme as:

$$[ \begin{matrix}( \frac{{U}_{n} - {\hat{U}}_{p}}{Δ \hat{t}} ) - T ( {U}_{n} ) {V}_{n} \\ M ( {U}_{n} ) ( \frac{{V}_{n} - {\hat{V}}_{p}}{Δ \hat{t}} ) - F ( {U}_{n} , {V}_{n} ) - {[ {C}_{U} ( {t}_{n} , {U}_{n} ) T ( {U}_{n} ) ]}^{T} {Λ}_{n} \\ {C}_{t} ( {t}_{n} , {U}_{n} ) + {C}_{U} ( {t}_{n} , {U}_{n} ) T ( {U}_{n} ) {V}_{n} + α C ( {t}_{n} , {U}_{n} )\end{matrix} ] = 0$$

In the above equations, Sₙ=[Uₙ Vₙ Λₙ]^{T} is the unknown next state, Ŝₚ is set to the combination of the two previous states −4/3Sₚ+⅓Sₚ₋₁ that are known, and the time step to ⅔ of the chosen step size Δt (set to 1/2000 for all the inventors' demonstrations). The system was assumed to be at rest at time to, setting the initial conditions S₀ accordingly (one can use BDF1 for the first timestep). To solve the resulting nonlinear equations for the next state Sₙ, one can use Newton's method where the system is linearized at the current iterate.

Turning now to fast simulation of robotic characters, the new dynamic simulation scheme (as described above) allows accurate simulation of robotic characters when actuating motors according to the artist-specified (input) motion profiles. Nevertheless, simulations are slow for complex characters due to the thousands of deformable DOFs. It becomes even prohibitively expensive as one seeks to optimize the motor profiles. This is because every objective evaluation during line search and every objective gradient evaluation requires a simulation of the entire animation.

To enable fast and accurate simulation of the robotic characters, the inventors relied on established subspace methods. However, the flexible components undergo large rotations, and modal models are poorly suited to represent them. Taking a closer look at the flexible bodies, the inventors observed that their motion is passive, driven by the inertial forces that are due to transformations of coupled rigid bodies. Moreover, their deformations are moderate with regards to the body coordinates of the latter. Inspired by multi-domain reduced simulation, the inventors, therefore, sought to integrate the reduced deformable dynamics in relative coordinates of one of the coupled rigid bodies, time-stepping the rigid body motion in global coordinates.

Before a discussion of the reduced formulation is presented, though, it may be useful to first describe full simulation in relative coordinates. For every deformable body, the adjacent rigid body can be chosen that primarily delivers its motion as reference. As discretized as discussed above, a point X∈ [symbol] in the reference domain Ω is mapped to its deformed position x(X, t)∈ [symbol] via interpolation of the nodal displacements u∈ [symbol] as:

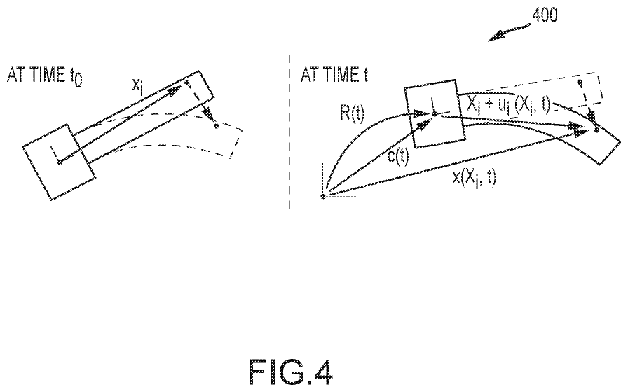

x(X,t)=X+u(X,t)u(X,t)=Φ(X)u(t) Eq. (11)

where Φ∈ [symbol] is the concatenation of 3×3 diagonal matrices set to the identity times the quadratic basis function of the corresponding node.
Discretized relative to one of the coupled rigid bodies (as shown in graphic 400 of FIG. 4), the reference point Xₗ∈ [symbol] in local coordinates of the coupled body is transformed to its global deformed configuration according to the following

x(Xₗ,t)=R(t)[Xₗ+Φₗ(Xₗuₗ(t)]+c(t) Eq. (12)

with the displacement uₗ and the basis Φₗ defined with regards to the local frame. To increase readability, the subscript l is dropped in the following discussion.

Starting from Eq. (1) and omitting the arguments in the interest of brevity, the weak form of the equations of motion can be formulated as:

∫_{Ω}Φ^{T}R^{T}(ρ\ddot{x}−∇_{X}·P^{T}−μg)dX=0⇒∫_{Ω}ρΦ^{T}R^{T}\ddot{x}dX=∫_{Ω}Φ^{T}R^{T}∇·P^{T}dX+∫_{Ω}ρΦ^{T}R^{T}gdX (13)

where the equations are transformed to local coordinates of the coupled body by multiplying with R^{T}. The integral on the left represents inertial forces (generalized mass times acceleration), and the two integrals on the right represent internal elastic and external gravitational forces, respectively. Plugging the second time derivative of the deformed configuration in relative coordinates (Eq. (12)) into the integral on the left (see supplemental materials at the end of this description for generalized mass matrices M1-M6 and for a detailed derivation), the inertial forces are formed that correspond to the linear and angular acceleration of the rigid bodies of the robotic systems, and the acceleration of the deformable bodies is provided as:

M_{ω}\dot{ω}M_{w}\dot{w}M\dot{v} Eq. (14)

M_{ω}(q,u)=−(M1+M2(u))R^{T}M_{w}(q)=M3R^{T} Eq. (15)

together with the fictitious centrifugal and Coriolis forces:

f_{cen}(q,u,ω)=Σⱼ(ω^{T}R(M4ⱼ+M5ⱼ(u))R^{T}ωe^{j})−(M6+Mu)(ω·ω) Eq. (16)

f_{cor}(q,ω,v)=−2M2(v)R^{T}ω Eq. (17)

that are due to use of the relative coordinate formulation, with eⱼ being the j-th column of the identity matrix.

It remains to discuss the first and second integrals on the left. Because the inventors rely on the Green strain (invariant under rigid body motion) and time-step the deformable bodies in their respective relative coordinates, the internal and damping forces for each individual deformable body can be discretized as usual (as discussed above). Because the constant gravity vector g is defined in absolute coordinates, it can be rotated to relative coordinates before integrating the third integral, setting the gravitational forces of the deformable body to f_{grav}(q)=M3R^{T}g.

In summary, to time-step deformable bodies in relative coordinates, the deformable body ODE, M\dot{V}−F=0, can be replaced in the simulation DAE (Eq. (8)) with the relative formulation of:

$$[ \begin{matrix}\overline{M} & & \\ & {I}_{c} & \\ {\underline{M}}_{w} & {\underline{M}}_{ω} & \underline{M}\end{matrix} ] [ \begin{matrix}\dot{w} \\ \dot{ω} \\ \dot{v}\end{matrix} ] \to [ \begin{matrix}\overline{f} \\ {τ}_{c} \\ \underline{f}\end{matrix} ] \qquad Eq . ( 18 )$$

where f is set to the forces −f_{cen}−f_{cor}−f_{damp}−fᵢₙₜ+f_{grav}.

The generalized mass matrices are either constant (M, M1, M3, M6), consist of constant blocks (M4), or are or consist of blocks that are linearly dependent on the displacements or velocities of the deformable bodies (see supplemental explanation at end of description). Hence, they are well-suited for precomputation.

Note that while these mass matrices may be similar to ones previously derived, the relative formulation differs in the following two fundamental ways. First, others' multi-domain simulation works on deformable bodies only, time-stepping each body in relative coordinates of the deformable subdomain of its parent. Hence, prior methods only work on hierarchical input and do not support loops. Because the inventors represent deformable relative to a rigid body and time-step all of the rigid bodies in global coordinates, the inventors' computational method can couple deformable bodies to several rigid bodies. This supports loops in the robotic character assemblies. Second, in the prior systems, frame rotations and accelerations were extracted from the previous state when the inertial forces were integrated. Hence, previous work involved integrating the latter explicitly. In contrast, the inertial forces in the new computational method depend on the next state of both the rigid and deformable bodies, which enables stable and accurate integration with an implicit scheme.

With regard to reduced simulation in relative coordinates, local deformations of individual deformable bodies can be expressed in a subspace while keeping the accuracy required for desired retargeting. Precomputing modes, Uᵣ∈ [symbol] , r «3n, one can time-step with the same system (Eq. (18)) as for full simulation, projecting it onto and solving in the reduced space instead. To compute constant (blocks of) mass matrices for the reduced system, the basis Φ can be set to the reduced basis ΦUᵣ (see supplemental explanations at the end of this description for derivations). Precomputing the reduced mass matrices, all of the inertial and gravitational forces can be integrated in O(r²) flops, without the need for computations in full space (with reliance on cubature for efficient evaluations of reduced internal forces and tangent stiffness). To construct the subspace for the constrained deformations, a PCA basis may be used. To this end, full simulations may be first run of the robotic characters followed by performing mass-PCA on the local displacements of each individual deformable component. It is worth pointing out that this defines subspaces for individual components instead of a single subspace for the entire character.

The next step or process performed by the new controller/design module with vibration suppression involves optimization. To retarget artist-specified (or other) input to a particular physical robot, it is desirable to try to minimize the difference of simulated target states, putting a priority on the suppression of low-frequency motion of large amplitude. Due to the flexibility in the robot's components, the robot deforms under gravity even if the target animation is slowed down to the degree where inertial forces can be neglected. Since one cannot hope to remove deformations due to gravity, a quasi-static solves is first performed with motor angles set according to the input profiles. Performing these quasi-state solves at the same time intervals as used for dynamic simulations defines the target states S(t). In the remainder of this section, a discussion is provided of how to minimize the distance of the simulated states S(t) to target states g(t) while suppressing visible low-frequency vibrations by making adjustments to parameterized motor profiles.

Regarding parameterization, the time-varying motor profiles can be represented as θᵢ(t,pᵢ) with a spline interpolation, parameterized with parameters pᵢ. Because C²-continuity is used to prevent infinite motor torques in simulations, B-Splines may be used. Collecting the parameters of all motors in a parameter vector p, the parameterized profiles are initialized by fitting them to the input profiles.

Regarding the retargeting objective, a first objective may be to minimize the distance between simulated and target states, integrated over the interval [0, T]. However, with this objective, the system is essentially being asked to remain as-rigid- or as-stiff-as-possible, preventing it from suppressing visible vibrations. The robotic characters studied herein included components that are assumed to be rigid in proximity to mechanical joints or motors. Thinking of them as articulated characters, the inventors aimed at suppressing low-frequency, global vibrations of large amplitude. Hence, the simulated positions of the rigid bodies are asked to remain as-close-as-possible to their target state in absolute coordinates with:

gₚₒₛ(t,U(p))=½∥c(t,U(p))−\tilde{c}(t)∥² Eq. (19)

If the positions and orientations of all rigid bodies adjacent to the flexible part of a component are all asked or set to remain as-rigid-as-possible, the process is again asking for stiffness and preventing compensation of global vibrations. However, for some applications it may be desirable to be able to penalize deviations of body orientations from a specified target (e.g., for the end effector attached to a robotic character that is holding an object that could spill contents from the object or the like such as a bartender character). To penalize differences between simulated and target orientations, a second objective can be introduced with:

gₒᵣᵢ(t,U(p))=½((rₓ·\tilde{r}_{z})²+(r_{y}·\tilde{r}_{z})²+(r_{z}·\tilde{r}ₓ)²) Eq. (20)

where the r-axes are the columns of the simulated and target rotations, R(t, U(p)) and \tilde{R}(t), of a rigid body. By integrating these differences over time, the retargeting objective is formulated as:

G(U(p))=∫₀^{T}g(t,U(t,p))dt Eq. (21)

g(t,U(t,p))=Σₖwₚₒₛ^{k}(t)gₚₒₛ^{k}+wₒᵣᵢ^{k}(t)gₒᵣᵢ^{k} Eq. (22)

where the time-varying weights, wₚₒₛ^{k}(t) and wₒᵣᵢ^{k}(t), for the body k provide a means to emphasize particular fractions of an animation. Note that these weights are constant in the sense that no time derivatives are required for numerical optimization. During retargeting, weights wₒᵣᵢ^{k} are set for most bodies at zero.

Regarding regularization, the objective measures performance with regards to absolute coordinates. To provide a means to penalize relative differences, hence closeness to the artistic input, a regularizer can be formulated that compares the current profiles to the input profiles. In addition, the motor profiles are set or asked to be smooth by penalizing high accelerations as follows:

rₚᵣₒⁱ(p)=½(θᵢ(t,p)−\tilde{θ}ᵢ(t))² and r_{acc}ⁱ(p)=½(\ddot{θ}ᵢ(t,p))² Eq. (23)

Analogously to these objectives, the regularization terms are weighed with weights that vary with time but are constant from an optimization perspective in:

R(p)=∫₀^{T}(Σᵢwₚᵣₒⁱ(t)rₚᵣₒⁱ+w_{acc}ⁱ(t)r_{acc}ⁱ)dt Eq. (24)

Note that the regularizer only depends on the spline parameters but not on the state of the robot.
With regard to DAE-constrained retargeting, to retarget motion profiles to the physical robots, the objective may be minimized under the dynamic equilibrium constraint, G=0, satisfied at every t∈[0,T]:

$${min}_{p} G ( p , U ( p ) ) + R ( p ) \\ Subject to G ( t , p , S ( t , p ) , \dot{S} ( t , p ) ) = 0 \\ and \\ S ( {t}_{0} ) = {S}_{0} \qquad Eq . ( 25 )$$

Because it is assumed that the system is at rest at the start of an animation sequence, the initial conditions S₀ do not depend on the parameters p.

At this point in the description, it may be useful to turn to the adjoint system and the objective gradient. While sensitivity analysis and adjoint method have become standard tools to implicitly enforce quasi-static equilibrium constraints in minimizations of design objectives, the computation of analytical gradients of the retargeting objective requires more machinery. Like for quasi-static problems, one can solve the equilibrium constraint whenever adjustments are made to spline parameters and then seek to evaluate the objective or objective gradient. To compute analytical gradients for DAE models, there are two options: forward and backward sensitivity analysis. If the number of parameters is small and not exceeding the number of simulation DOFs, forward analysis is preferable. In all other circumstances, backward analysis is the method of choice. Because the number of the state variables in the new computational tool is in the order of hundreds (for reduced simulation) and the number of parameters in the order of thousands, the inventors relied on backward analysis (with the understanding forward analysis may be practical in other applications).

Pointing the reader to the supplemental material at the end of this description for a detailed derivation, a recipe is provided here of how the inventors compute analytical gradients. Upon parameter changes, the simulation DAE, G=0 for t∈[0, T], is solved and the states S(t) are stored for later use. By time-stepping backwards, the linear DAE is then solved with:

$$[ \begin{matrix}E & \\ & {M}^{T}\end{matrix} ] \dot{λ} = ( - [ {\dot{U}}^{T} {M}_{U}^{T} ] + [ \begin{matrix}{G}_{U}^{T} \\ {G}_{V}^{T} \\ {G}_{Λ}^{T}\end{matrix} ] ) λ + [ \begin{matrix}{g}_{U}^{T} \\ {g}_{V}^{T}\end{matrix} ] \qquad Eq . ( 26 )$$

with initial conditions, λ(T)=0, for the adjoint variables λ(t). In evaluations of gradients g_{U} and g_{V} of the objective, Jacobians G_{U}, G_{V}, and G_{Λ} of the constrained dynamics equations (Eq. (10)) and the generalized mass matrix M and its Jacobian with regard to generalized positions, the states S(t) can be used from the solve of the simulation DAE. Then, the objective gradient can be evaluated as:

$$\frac{dG}{dp} = - {\int }_{0}^{T} {λ}_{T} {G}_{p} dt \qquad Eq . ( 27 )$$

where the states S(t) are used from forward-stepping G=0 in evaluations of Jacobian Gₚ and λ(t) from backward-stepping the corresponding adjoint system.

Discretizing both DAEs (Eqs. (10) and (26)) with a BDF2 scheme with the same time interval (dividing the interval [0, T] by the number of desired time steps), correspondence is ensured along the time axis. For numerical integration of the objective and objective gradient, one can rely on a cubic Simpson rule and for minimization of the objective on a standard BFGS.

Now, it may be useful to describe the results of use of the new vibration-minimizing motion retargeting technique to generate output and use of this output to control robots. The inventors used the computational framework to optimize six examples with seven different motion sequences, ranging from didactic mechanical systems to full-body robotic characters. By progressively increasing the complexity of the assemblies, the target motion sequence, and the physical size of the demos, the inventors have demonstrated the suitability of their method for complex and large-scale robotic systems. For all the examples, the following were generated (and are shown, at least in part, in the attached figures): the target animation sequence, the naïve playback of the target animation on the physical robot or robotic character, and the playback (i.e., control of the robot with control signals generated based on the output of the new computational framework) of the optimized animation on the physical robot or robotic character. The self-weight gravity was modeled across all the deformable and rigid components in the results, and the static configuration under gravity was used as the initial conditions to the simulation. The target animation trajectory was estimated by running a quasi-static simulation through the whole animation sequence.

Regarding fabrication, all the demonstrators/test robots were driven with Dynamixel XM-430-W210 servomotors, controlled from a PC through a Dynamixel U2D2 interface. The servos provided sufficiently high torque such that one can assume them to follow the specified motor angle trajectory with no derivation. The test robots were assembled using a combination of off-the-shelf Dynamixel mounting brackets, a small number of custom aluminum machined connectors, spring steel rods (diameters 4 and 5 mm) and 3D-printed parts. Structural parts were printed with Digital ABS material on an Objet Connex 350 and parts for visual appearance were printed with PLA on an Ultimaker 2+. Flat parts for the 13-DOF robot were laser cut from acetal sheets. The 100 g and 200 g weights were machined from brass.

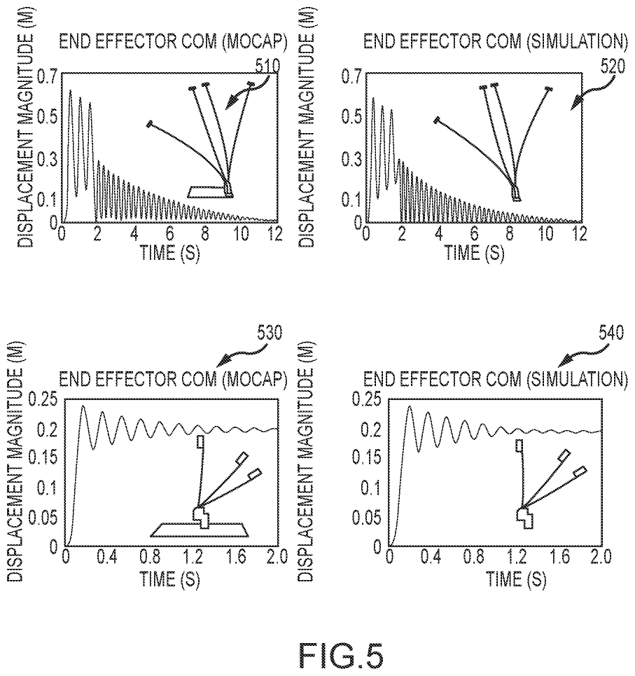

Regarding material fitting, in order to accurately simulate the dynamics, the physical parameters (such as Young's modulus and damping coefficients) were fitted to the deformable rod and the 3D-printed material by comparing the simulation results to the motion captured data. FIG. 5, with graphs 510, 520, 530, and 540, shows the physical setup the inventors used to mount the deformable body, either a rod or a 3D-printed piece, on a single-DOF motor. As shown, using motion capture data, one can fit elastic and damping properties for FEM simulation of the deformable rod and 3D-printed material. Parameters were fitted with bisection, and the final parameters were obtained within five iterations. The simulation data fits well with the mocap data, and the obtained material parameters were in agreement with values from the literature. In the material fitting, a 100 g rigid mass was attached to the end of the deformable body, such that the physical properties were measured in the frequency range of interest. The deformable body vibrates due to the motor rotation, and an OptiTrack system was used to capture the end effector motion. It was observed that the reduced simulation results closely matched the captured motion (see graphs 520 and 540). The simulation accuracy benefits significantly from using quadratic finite elements and due to the implicit BDF2 scheme one does not observe numerical damping problems.

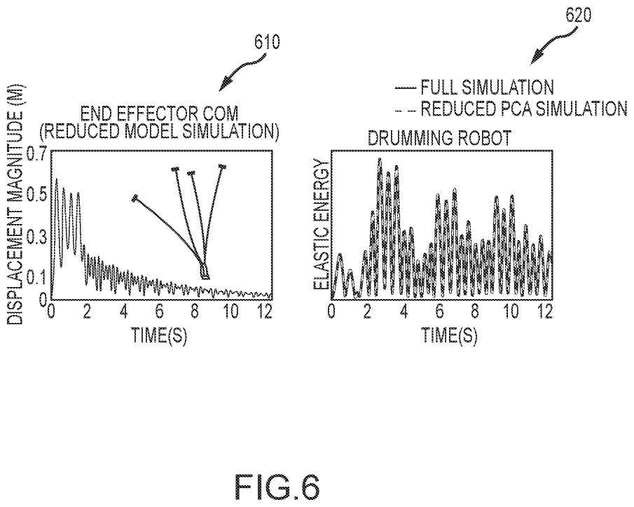

With regard to validation, in the experiments, mass-PCA modes were used instead of standard linear modes for multiple reasons. The vibrations in the systems were moderately large, and a large number of linear modes would therefore be required to express the deformation. For large deformations, linear modes can be augmented with modal derivatives, which are known to provide visually-good dynamics. However, in many cases, the inventors found these to not perform well in their present application as illustrated in the graphs 610 and 620 of FIG. 6 (see graph 610, particularly), where 80 linear modes and modal derivatives (40 FPS) were used but still saw significant mismatch. Graph 610 shows results of using linear modes and modal derivatives, where the reduced simulation activates circular motion and the dynamics frequency does not match the mocap data (see graphs 510 and 530 of FIG. 5). Graph 620 shows the results of applying the mass-PCA basis reduced from the full boxer simulation data to the unseen drumming motion, which shows that the reduced simulation very closely matches the full simulation data on the untrained motion. In contrast to the results of graph 610, the PCA modes (graph 520 of FIG. 5) match the captured data well using eleven modes (275 FPS) Moreover, with a sufficient number of PCA modes one can achieve similar accuracy to full simulation, whereas with linear and modal derivatives one has to tune material properties to non-physical values due to the numerical stiffening. For the present animation retargeting problem, PCA modes suffice to express the observed vibrations and can even extrapolate to different motions with similar vibrations (see graph 620 in FIG. 6). Different from standard linear modes, PCA modes do not introduce any locking artifacts due to constraints as the full simulation enforces the constraints across the motion.

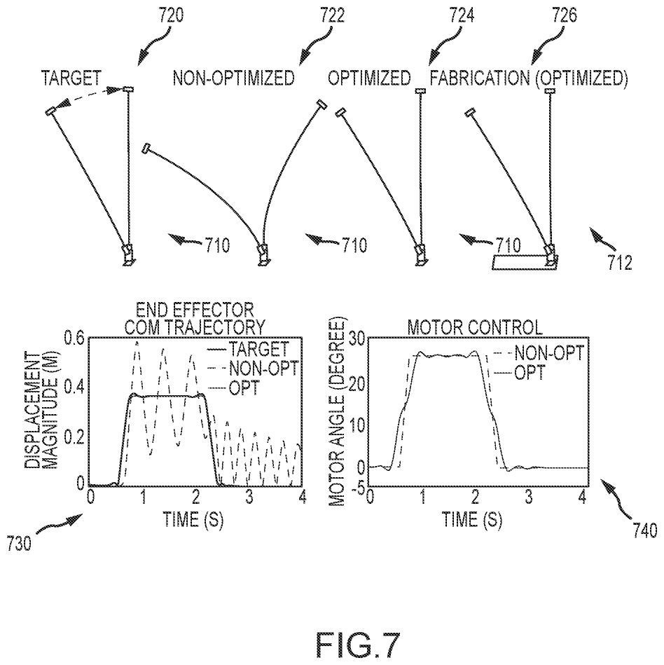

The first example is a robotic system in the form of a single vertical deformable rod (spring steel, 70 cm height) mounted on a servo-motor, with a 100 g mass attached at the end. FIG. 7 illustrates (with animation frames) testing of such a target robot 710 and fabricated robot 712, during target animations 720, non-optimized playback 722, optimized playback 724, and optimized control of a fabricated robot 712 along with graphical representations or trajectory plots 730 and 740 of the test results. As shown, by preempting the movement of the input animation (see graph 740), the optimized control produces a motion sequence that closely matches the target, as indicated by the animation frames of graphs 720-726 and trajectory plot of graph 730.

In this test, starting from the vertical rest configuration, the motor was rotated by 30 degrees, paused for 1.5 seconds, and then returned to the rest configuration. With the non-optimized piecewise linear motor control, the compliant rod vibrates substantially around the target poses and deviated from the target motion significantly. The optimization taught herein uses the center of mass (COM) trajectory of the end effector as the objective. It can be observed that the optimized motor control suppresses the vibration, while the timing of the intended motion is kept as closely as possible. It can be seen that this is done in part by smoothing out the transitions to poses and, in part, by preempting the motions and adding deformations ahead that cancel oscillations.

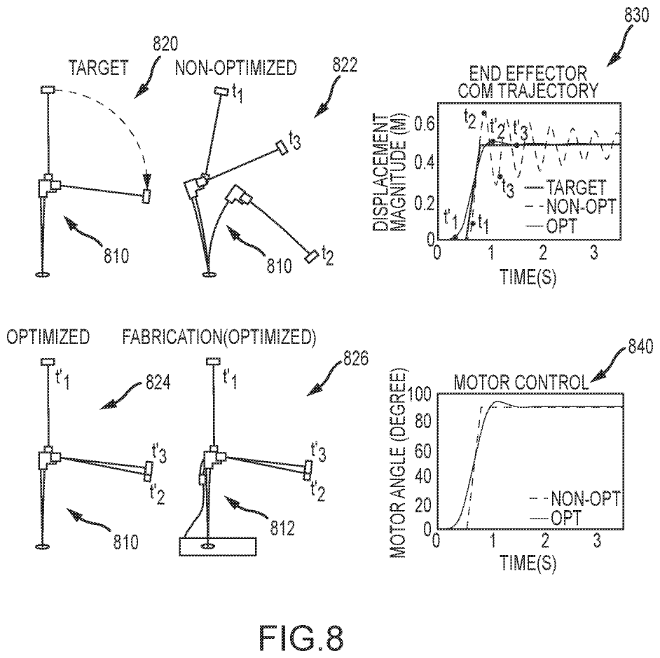

Extending the first example, a second exemplary test robot can be provided by moving the motor from the base to the middle where two 30 cm compliant rods can be connected. FIG. 8 illustrates results of testing of such a single motor two rod robot with the target robot 810 and fabricated robot 812 with animation frames during target 820, non-optimized playback 822, optimized playback 824, and optimized controlled motion 826 of fabricated robot 812 along with graphs 830 and 840 showing test results including end effector trajectory and motor control. Compared to the piecewise linear motor control, the optimized smooth control signal used for fabricated robot 812 as shown at 826 successfully suppresses the variation to be under a very small amount. Similar to the first example, a 200 g rigid mass was attached as the end effector. Starting from the straight vertical pose, the upper rod was rotated by 90 degrees to a horizontal pose. Due to the mass inertia, the lower rod deforms and under the non-optimized motor control, the system vibrates significantly. The optimization process taught herein uses the COM of both the end effector and the motor in the objectives. FIG. 8 shows that the optimization result successfully removes the unwanted vibrations to a large degree.

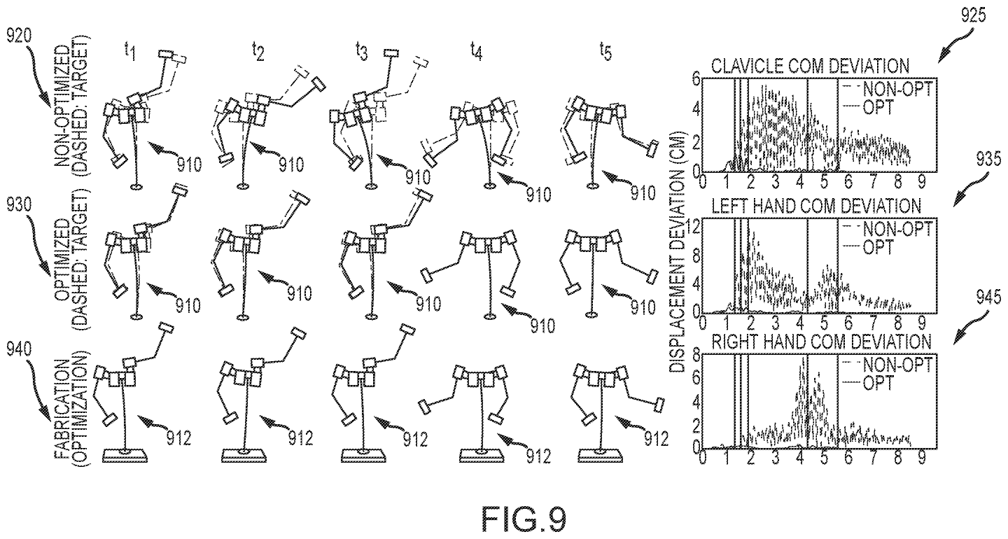

As a third example, the robot takes the form of a dancer to increase the complexity to a 4-DOF character assembly where a 25 cm rod that represents the dancer's body and two arms are connected at the clavicle. This can be seen in FIG. 9.

In this test, each arm of the robot included two motors at the shoulder, one deformable rod as the arm, and a 200 g mass as the hand. The target motion was an 8.5-second dance sequence featuring expressive 3D arm movements. A naïve transfer of the motion sequence to the servo-motors causes very significant vibrations, in particular due to the waving motion of the left hand (see series 920 in FIG. 9), causing the resulting motion of the physical character to very different from the target movements (input animation).

FIG. 9 shows a target/design robot 910 performing a series of movements 920 (with the robot shown over the top of input/target animations) with resulting COM deviation in graph 925, with the target/design robot 910 performing a series of optimized movements 930 with resulting COM deviation in graph 935, and with the fabricated robot 912 performing the series of optimized movements 940 with resulting COM deviation in graph 945. Five representative frames are provided for non-optimized and optimized simulation overlaid with the target animation and for the retargeted optimized motion on the physical character. Displacement error visualization on the clavicle, left, and right hand are provided in graphs 925, 935, and 945. Here, the presented optimized result corresponds to the first experiment where all the matching targets were assigned with a weight of unity. The first three frames show the waving motion while the last two frames are dancing poses. The non-optimized one shows substantial vibrations on the body rod which lead to large deviation everywhere whereas the optimized control successfully removes the excess vibration. Note, the vibration-minimizing control method does not completely cancel the deviation during the waving sequence but with such a small amount of body rod deformation the vibration caused from waving can largely be cancelled for the subsequent motion.

In order to suppress the undesirable vibrations, the control signals for the four motors were optimized such that the COM trajectories of both the hands and the clavicle match the target as closely as possible. To demonstrate the user control over the optimization results, the inventors experimented with three different sets of weights on the target matching terms. In the first experiment, a weight of unity was assigned to all the target points. The resulting motion was close to the target animation sequence, without inducing noticeable vibrations. However, for the waving sequence, the displacement of the left hand end effector was mostly achieved by the deformation of the body rod as opposed to the rotation of the corresponding shoulder motors. Therefore, in the second experiment, the objective weight for trajectory matching was increased at the clavicle by 100 times. As expected, little vibration was still achieved across the motion sequence and, at the same time, the deformation at the torso was also reduced, at the expense of weakening the waving motion. The system also allows for time-varying weights, enabling the user to control the significance of separate motion segments. In the third experiment, in order to restore the waving motion, a time-varying weight was assigned to the left hand over the motion by increasing its weight by 100 times specifically for the waving segment. Interestingly, in this scenario, the right arm deviates more from the input target and performs a counteracting motion to balance the wave and prevent vibrations. These examples demonstrate that the new control system is able to suppress vibrations in multiple different ways and can, thus, be tuned by the user in order to match a particular artistic intent.

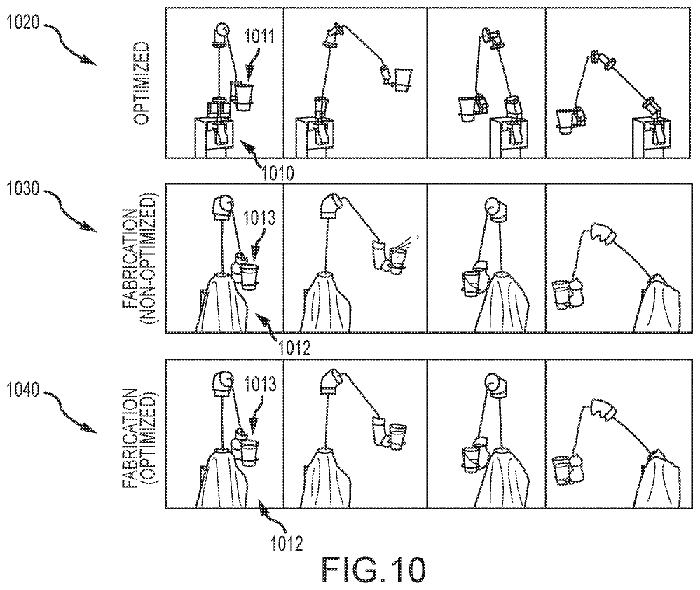

As well as being visually displeasing, vibrations can also negatively impact the functional performance of robot characters. In a fourth demonstrator/test robot, a 4-DOF bartender robot arm (3-DOF translation, 1-DOF rotation at the end effector) is studied, that is holding a glass of water and moving it through three locations. This is shown in FIG. 10 with target robot 1010 holding water in glass 1011 and with fabricated robot 1012 holding water in glass 1013. The top row provides a set of frames 1020 of the simulated optimization result for four frames in the animation/motion sequence, with the target being matched almost perfectly. The middle row provides another set of frames 1030 showing the physical robot 1012 executing the non-optimized trajectory and spilling the drink (frames two and four), and the bottom row provided a set of frames 1040 showing the physical robot 1012 following the optimized trajectory with no spillage (i.e., little to no unwanted vibrations).

In the bartender robot test, the height of the robot (without the base) was 45 cm. For this demonstration/test, the controller was operated so as to not only try to match the position trajectories at the elbow and end effector but also match the end effector orientation such that the glass remains upright. The input motion trajectory when played back on the robot, causes the robot to spill the drink due to the vibration. By running the new optimization, though, on this input, the robot can be controlled to perform the same motion sequence without spilling the drink. It was assumed that the water in the cup behaves as a rigid body of fixed mass, and, although this is an oversimplification, it can be seen that it is sufficient for this testing. FIG. 10 shows the optimized simulation result at 1030, the non-optimized motion at 1020 that causes the drink to spill, and the optimized robot 1012 at 1040 that does not spill the drink. This test showcases the new method and indicates it has applications in functional areas of robotics (not just visual applications).

In another test case, a rapper's arm was controlled to reduce vibration to demonstrate that the method supports mechanical systems with kinematics loops. The robotic system was simulated as shown with robot 1110 under non-optimized control with sequence 1120 in which the arm deviates significantly from the input sequence. Optimized control is shown in sequence 1130 for simulated robot 1110 and provides dynamic motion that is visually indistinguishable from the target. The tested robotic system (simulated at 1110) included two 3D-printed compliant arm components connected with a 4-bar linkage and four motors controlling the 3D shoulder motion and a 1-DOF elbow motion. Unlike conventional rigid 4-bar linkages, the test rapper robot had two compliant links and two rigid links that were connected with two hinge joints, one universal joint and one spherical joint in order to obtain the correct number of constraints while allowing for the deformable components to move out-of-plane. The input motion was designed to be a rapping sequence where the arm is moving in a wide-range 3D space. The optimized motor controls successfully remove the substantial vibrations that are present when operating the robot with the non-optimized control input.

The scalability of the computational framework was examined by retargeting a drumming motion sequence for a 13-DOF full-body robot with a height of 80 cm. This is shown with simulated/target robot 1210 performing non-optimized motion overlaid with target motion in frames 1220, with simulated/target robot 1210 performing optimized motion in frames 1230, and with a fabricated physical robot 1212 performing the retargeted motions in frames 1240. With the non-optimized control, the vibration is excessive whereas vibration is nearly invisible with optimized control as seen in sequence 1230.

Each arm had 3 DOFs at the shoulder and 1 DOF at the elbow. In addition, the upper body was actuated with five motors controlling the motion of the head, neck, torso, spine, and pelvis. The character legs were two 45 cm rods fixed at a base, and the lower arms were 10 cm rods. The entire drumming motion lasted 10 seconds. It can be seen that the main deformation mode, which is significantly excited by the drumming motion, was a backward-forward swaying motion. Interestingly, for the non-optimized case, the vibration amplitude exhibits significant periodic vibration over time (at some points being close to zero), and this is seen both in the simulated and the physical systems. This would make it very challenging to manually smoothen or offset control for vibration suppression. The optimization provided by the new controller/design system targets the center of mass trajectories of the head, pelvis, and both hands. Without any noticeable degeneracy of motion quality, the vibration error was successfully suppressed for the whole system (e.g., peak amplitude reduced from 7 cm to 1 cm).

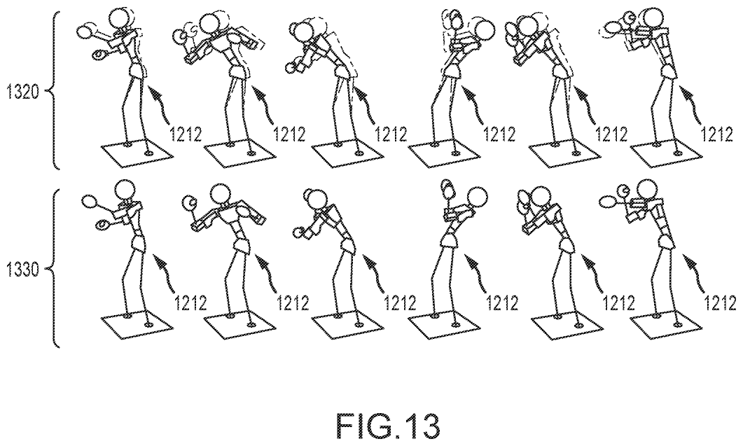

Finally, the inventors showed that a different motion sequence, i.e., boxing, can be retargeted to the same full-body character as the drumming robot, where the inventors only replace the hands with boxing gloves. FIG. 13 illustrates the robot 1210 (modified to include boxing gloves as end effectors rather than hands) in a series of movements with frames 1320 during non-optimized control (playback of input animation) and in a series of movement with frames 1330 during optimized control, which largely removes the vibration and matches the target motions with high visual quality. The physical robot executing the optimized trajectory is shown in FIG. 1. Unlike the drumming motion with repetitive beats, the boxing motion contains more fast and abrupt motions. The nave retargeting causes excessive vibrations, especially when the character dodges and moves his upper body backward and forward. With the same objective and optimization parameters as for the drummer, the optimized motor signals (output by the optimization module taught herein) control the deviation error under 1.5 cm (compared to 9 cm before the optimization) while preserving the input animation without noticeable visual difference.

With regard to one useful practical implementation of the method in a computing system/robot controller (offline or online and offboard or onboard the robot being controlled), the simulations and optimizations were performed on a machine with an Intel Core i7700 processor (4 cores, 4.2 GHz) with 32 GB of RAM. The evaluation of internal force and tangent stiffness matrices of the deformable bodies are performed in multi-threads. For minimization, the inventors relied on the standard interior-point method and BFGS as implemented in the KNITRO software package. In the experiments, the relative residual tolerance was set to 10⁻⁴ and the maximum number of minimization iterations to 100. The minimizations converged well and substantially decreased the vibrations from the input sequence, without sacrificing the quality of motion.

In the above description, a computational tool has been presented that retargets artist-created animation (or other input animation) onto physical robotic characters while minimizing unwanted vibrations due to system dynamics. Using model reduction to speed up simulation, the two-way coupling between rigid bodies and flexible bodies was accurately modeled. Leveraging this simulation model, the motor control was optimized via a continuous adjoint method such that the physical character motion matches the artistic intent as closely as possible. The approach provides an automated way to retarget digital animations onto physical characters and could also be used to evaluate the design of a physical robot before it is built. Moreover, by suppressing vibrations with the tuning of motor trajectories, the tool enables the design of expressive robotic characters that can be less stiff and, therefore, lighter, cheaper, and more accessible to all.

Beyond the application of motion retargeting, the pipeline incorporates elements that will in general be valuable for fast simulation of multi-body systems incorporating coupled rigid-body dynamics and deformable bodies. The simulator captures the dynamic response of the physical characters well. However, it can be observed that there is still some deviation between the simulated dynamics and physical system, leading to small residual vibrations. This is likely due to the assumptions of perfectly stiff motor controls and mechanical joints, which in reality will have some non-infinite stiffness. A promising approach for eliminating these small residual vibrations would be to implement an online closed-loop controller on the robot, where the tracked marker point trajectory is measured, and the motor control adjusted accordingly. This would make the approach more robust to modeling errors and to unexpected variations in the external loads.

In one implementation, the user decides which components to model as rigid and which to model as deformable. In many applications, this distinction is easy to make. However, for very large and complex assemblies, it could be beneficial to automate this selection. While the design of the robotic characters is held fixed and focus is provided on the control problem herein, the formulation of the computational tool would also support the optimization of parameterized dimensions of components or the positions and orientations of mechanical joints.

Below, implementation-ready generalized mass matrices are provided for the relative coordinate formulation (with detailed derivatives provided afterwards). In derivations of mass matrices, one can make use of the observation that the interpolated displacements can be written as sums of columns of the 3×3n basis matrix times a single entry uₖ of the displacements u∈ [symbol] to provide:

u(X,t)=Φ(X)u(t)=ΣₖΦₖ(X)uₖ(t) Eq. (28)

The mass matrices are:

$$\underline{M 1} = {\int }_{Ω} {{ρΦ}^{T} [ X ]}_{x} dX \\ \underline{M 2} ( u ) = {\sum }_{k} ( {\int }_{Ω} {{ρΦ}^{T} [ {Φ}_{k} ]}_{k} dX ) {u}_{k} \\ \underline{M 3} = {\int }_{Ω} {ρΦ}^{T} dX \\ {\underline{M 4}}_{j} = {\int }_{Ω} ρ X {Φ}_{j}^{T} dX \\ {\underline{M 5}}_{j} = {Σ}_{k} ( {\int }_{Ω} {ρΦ}_{k} {Φ}_{j}^{T} dX ) {u}_{k} \\ \underline{M 6} = {\int }_{Ω} {ρΦ}^{T} XdX \qquad Eq . ( 29 )$$

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

The following provides supplemental materials relevant to the materials discussed in detail above including derivations of the relative coordinate formulation of the equations of motion and derivations of the adjoint system that is used to compute analytical gradients for the retargeting optimization.

Turning first to derivation of the relative coordinate formulation, the deformed configuration is provided by:

x(X,t)=R(t)[X+Φ(X)u(t)]+c(t)

In deriving the corresponding velocity and acceleration, the arguments in the expression x=R(X+Φu)+c are dropped.

The velocity of the deformed configuration is:

$$\begin{matrix}\dot{x} = \dot{R} ( X + Φ u ) + R Φ \dot{u} + \dot{c} \\ = {[ ω ]}_{x} R ( X + Φ u ) + R Φ v + w\end{matrix}$$

and its acceleration:

\ddot{x}=\ddot{R}(X+Φu)+2\dot{R}Φ\dot{u}+RΦü+\ddot{c}

$$= ( {[ \dot{ω} ]}_{x} R + {[ ω ]}_{x}^{2} R ) ( X + Φ u ) + {2 [ ω ]}_{x} R Φ v + R Φ \dot{v} + \dot{w} \\ = R Φv + {[ \dot{ω} ]}_{x} R ( X + Φ u ) + \dot{w} + {[ ω ]}_{x}^{2} R ( X + Φ u ) + {2 [ ω ]}_{x} R Φ v \\ \underbrace{= R Φ \dot{v}}_{db acc .} \underbrace{- R ( {[ X ]}_{x} + {[ Φ u ]}_{x} ) {R}^{T} \dot{ω} + \dot{w}}_{Rb acc .} + \underbrace{{R [ {R}^{T} ω ]}_{x}^{2} ( X + Φ u )}_{Centrifugal acc .} + \underbrace{2 {R [ {R}^{T} ω ]}_{x} Φ v}_{Coriolis acc .}$$

In the above derivations, the identities \dot{R}=[ω]ₓR and \ddot{R}=[\dot{ω}]ₓR+[ω]ₓ²R are used in the first three lines. Because [R^{T}a]×b=R^{T}a×R^{T}Rb=R^{T} [a]ₓRb, the identity R^{T} [a]ₓR=[R^{T}a]ₓ holds. For acceleration terms that have subexpressions [a]ₓRb, the latter identity is used to move the rotation matrix to the left RR^{T} [a]ₓ Rb=R[R^{T}a]ₓb. For the rigid body acceleration term, the identities [a]ₓb=[b]ₓa and [a+b]ₓ=[a]ₓ+[b]ₓ are used.

To form the inertial forces,

∫_{Ω}Φ^{T}R^{T}ρ\ddot{x}dX=∫_{Ω}ρΦ^{T}R^{T}\ddot{x}dX

the individual acceleration terms are integrated. When integrating the acceleration of the deformable body (db acc.), it is seen why it is useful to multiply with the transpose of the rigid body rotation:

∫_{Ω}ρΦ^{T}R^{T}RΦ\dot{v}dX=(∫_{Ω}ρΦ^{T}ΦdX)\dot{v}=M\dot{v}

Integration results in the same mass matrix as for the absolute coordinate formulation M∈

[symbol]

Integration of the rigid body acceleration (rb acc.) leads to a force:

−(M1+M2(u))R^{T}\dot{ω}(i)+M3R^{T}\dot{w}

that depends on a total of three mass matrices:

M1=∫_{Ω}ρΦ^{T}[X]ₓdX

M2(u)=∫_{Ω}ρΦ^{T}[Φu]ₓdX

M3=∫_{Ω}ρΦ^{T}dX

where M1∈ [symbol] and M3∈ [symbol] are constant and M2∈ [symbol] depends on the displacement. To efficiently computer M2, the displacement Φu is substituted with Σₖ₌₁³ⁿΦₖuₖ to give:

$$\underline{M 2} ( u ) = {\sum }_{k = 1}^{3 n} ( {\int }_{Ω} {{ρΦ}^{T} [ {Φ}_{k} ]}_{k} dX ) {u}_{k}$$

and precompute the 3n×3 blocks in brackets.

To derive the centrifugal forces, the corresponding acceleration (centrifugal acc.) is first split into two terms:

R((R^{T}ω)·(X+Φu))R^{T}ω−R(X+Φu)(ω·ω)

where the identity a×(b×c)=(a·c)b−c(a·b) is applied to the subexpression [R^{T}ω]ₓ² (X+Φu)=(R^{T}ω)×(R^{T}ω)×(X+Φu).

To integrate the first term, the integral is split into a sum of integrals and the transpose of the j-th column of Φ:

$$\begin{matrix}{\sum }_{k = 1}^{3 n} ( {\int }_{Ω} {ρΦ}_{j}^{T} ( {R}^{T} ω ) \cdot ( X + {Φ}_{k} {u}_{k} ) ) {R}^{T} ω dX = & {ω}^{T} R ( {\sum }_{k = 1}^{3 n} {\int }_{Ω} ρ ( X + {Φ}_{k} {u}_{k} ) {Φ}_{j}^{T} dX ) {R}^{T} ω \\ = & {ω}^{T} R ( ( {\int }_{Ω} ρ X {Φ}_{j}^{T} dX ) + {\sum }_{k = 1}^{3 n} ( {\int }_{Ω} {ρΦ}_{k} {Φ}_{j}^{T} dX ) {u}_{k} ) {R}^{T} ω\end{matrix}$$

The derivation of the second term is straightforward.

To form the resulting centrifugal forces:

$${f}_{cen} ( q , u , w ) = {\sum }_{j = 1}^{3 n} {ω}^{T} R ( {\underline{M 4}}_{j} + {\underline{M 5}}_{j} ( u ) ) {R}^{T} ω {e}_{j} - ( \underline{M 6} + \underline{M} u ) ( ω \cdot ω )$$

where eⱼ is the j-th column of the 3n×3n identity matrix, and the additional mass matrices are precomputed:

$${\underline{M 4}}_{j} = {\int }_{Ω} ρ X {Φ}_{j}^{T} dX$$

$${\underline{M 5}}_{j} ( u ) = {\sum }_{k = 1}^{3 n} ( {\int }_{Ω} {ρΦ}_{k} {Φ}_{j}^{T} dX ) {u}_{k} \\ \underline{M 6} = {\int }_{Ω} {ρΦ}_{j}^{T} XdX$$

Analogously to M2, the blocks in brackets for matrix M5ⱼ are precomputed. Because Φ has 3n columns, there are 3n 3×3 matrices M4ⱼ and M5ⱼ(u)(j=1, . . . , 3n). M6 is a 3n vector.

To derive the Coriolis force:

f_{cor}(q,ω,v)=−2M2(v)R^{T}ω

[R^{T} ω]ₓ is substituted for a and Φv for b in the identity [a]ₓb=−[b]ₓa in the Coriolis term (Coriolis acc.) prior to integration. For this term, M2 is reused, setting its parameter to the velocities v instead of the displacement u. Note that the fictitious centrifugal and Coriolis forces depend on q because quaternions are used instead of rotation matrices. In some implementations, rotations may be extracted from quaternions R(q).

In a reduced formulation, the displacements are defined as:

u(X,t)=Φ(X)Uᵣuᵣ(t)

To derive the reduced mass matrices and inertial forces, the full basis Φ(X) can be replaced with the reduced basis Φᵣ(X)=Φ(X)Uᵣ in the above derivations. Again, arguments are dropped for conciseness. Φᵣ is now a 3×r-matrix, uᵣ a r-vector, and ϕ_{r,k}∈ [symbol] the k-th column of Φᵣ.

The mass matrices are:

$${\underline{M}}_{r} = {U}_{r}^{T} \underline{M} {U}_{r} = {E}_{rxr}$$

$${\underline{M 1}}_{r} = {U}_{r}^{T} \underline{M 1}$$

$${\underline{M 2}}_{r} {u}_{r} = ( {\sum }_{k = 1}^{r} ( {\int }_{Ω} {{ρΦ}_{r}^{T} [ {Φ}_{r , k} ]}_{x} dX ) {u}_{r , k} )$$

$${\underline{M 3}}_{r} = {U}_{r}^{T} \underline{M 3}$$

$${\underline{M 4}}_{r , j} = {\int }_{Ω} ρ X {Φ}_{r , j}^{T} dX$$

$${\underline{M 5}}_{r , j} ( {u}_{r} ) = {\sum }_{k = 1}^{r} ( {\int }_{Ω} {ρΦ}_{r , k} {Φ}_{r , j}^{T} dX ) {u}_{r , k}$$

$${\underline{M 6}}_{r} = {U}_{r}^{T} \underline{M 6}$$

where numerical integration is used to precompute the blocks in brackets for M2ᵣ(uᵣ) and M5_{r,j}(uᵣ), and the j-th 3×3 matrices M4_{r,j}.

The inertial forces corresponding to the deformable body (db acc.) reduce to:

Uᵣ^{T}MUᵣ\dot{v}ᵣ=\dot{v}ᵣ

and for the rigid body (rb acc.) to:

−(M1ᵣ+M2ᵣ(uᵣ))R^{T}\dot{ω}+M3ᵣR^{T}\dot{w}

The centrifugal force becomes:

$${f}_{cen} ( q , {u}_{r} , ω ) = {\sum }_{j = 1}^{r} {ω}^{T} R ( {\underline{M 4}}_{r , j} + {\underline{M 5}}_{r , j} ( u ) ) {R}^{T} ω {e}_{j} - ( \underline{M 6} + \underline{M} u ) ( ω \cdot ω )$$

where eⱼ is the j-th column of the r×r identity matrix, and the reduced Coriolis force is:

f_{cor}(q,ω,vᵣ)=−2M2ᵣ(vᵣ)R^{T}ω

With regard to derivation of the adjoint system, one is required to solve the retargeting problem:

$${min}_{P} G ( p , U ( p ) ) + R ( p )$$

subject to G(t,p,S(t,p),\dot{S}(t,p))=0 and S(0)=S₀(p)

which requires the computation of an analytical gradient

$$\frac{d G ( p , U ( p ) )}{d p} .$$

While the presented semi-implicit DAE system can easily be brought into standard Hessenberg index-2 form, we prefer to keep the mass matrix M on the left-hand side because it simplifies the adjoint DAE.

To keep the derivation general, the objective is assumed to depend on the state S for the first part of the derivation:

G(p,S(p))=∫₀^{T}g(t,p,S(p))dt

The augmented objective with continuous, time-dependent Lagrange multipliers 40 for the above problem is:

I(p,S)=G(p,S)∫₀^{T}λ^{T}G(t,p,S,\dot{S})dt

Because the DAE system is satisfied at every t, the total derivative of G and 1 are equivalent such that:

$$\frac{dG}{dp} = {\int }_{0}^{T} ( {g}_{p} + {g}_{s} {S}_{p} ) dt - {\int }_{0}^{T} ( {G}_{p} + {G}_{S} {S}_{p} + {G}_{\dot{S}} {\dot{S}}_{p} ) dt$$

where subscripts are used for partial derivatives. Note that Sₚ and \dot{S}ₚ are total derivatives.

Integration by parts of the term λ^{T}G_{\dot{S}}\dot{S}ₚ:

$${\int }_{0}^{T} {λ}^{T} {G}_{\dot{S}} {\dot{S}}_{p} dt = ( {λ}^{T} {G}_{\dot{S}} {S}_{p} ) {\vert}_{0}^{T} - {\int }_{0}^{T} \frac{d}{dt} ( {λ}^{T} {G}_{\dot{S}} ) {S}_{p} dt$$

enables the dependence on \dot{S}ₚ to be turned into a dependence on Sₚ:

$$\frac{dG}{dp} = {\int }_{0}^{T} ( {g}_{p} + {λ}^{T} {G}_{p} ) dt - {\int }_{0}^{T} ( - {g}_{S} + {λ}^{T} {G}_{S} - \frac{d}{dt} ( {λ}^{T} {G}_{\dot{S}} ) ) {S}_{p} dt - ( {λ}^{T} {G}_{\dot{S}} {S}_{p} ) {\vert}_{0}^{T}$$

By setting the term in brackets of the second integrand to zero, the adjoint system is then formed:

$$\frac{d}{dt} ( {λ}^{T} {G}_{\dot{S}} ) = {λ}^{T} {G}_{S} + {g}_{S}$$

Applying the chain rule and transposing the system, the adjoint DAE is formed:

$${G}_{\dot{S}}^{T} \dot{λ} = ( - {( \frac{d {G}_{\dot{S}}}{d t} )}^{T} + {G}_{S}^{T} ) λ + {g}_{S}^{T}$$

For this particular DAE system:

$$G = [ \begin{matrix}\dot{U} - T ( U ) V \\ M ( U ) \dot{V} - F ( U , V ) - ( {C}_{U} ( t , U ) T ( U ) {)}^{T} Λ \\ {C}_{t} ( t , U ) + {C}_{U} ( t , U ) T ( U ) V + α C ( t , U )\end{matrix} ] = 0$$

the Jacobian with regard to the state is:

G_{S}=[G_{U}(t,U,V)G_{V}(t,U,V)G_{Λ}(t,U)]

with columns:

$${G}_{U} = [ \begin{matrix}- {T}_{U} ( U ) V \\ {M}_{U} ( U ) \dot{V} - {F}_{U} ( U , V ) - {( {C}_{U , U} ( t , U ) T ( U ) + {C}_{U} ( t , U ) {T}_{U} ( U ) )}^{T} \\ {C}_{t , U} ( t , U ) + ( {C}_{U , U} ( t , U ) T ( U ) + {C}_{U} ( t , U ) {T}_{U} ( U ) ) V + α C ( t , U )\end{matrix} ]$$

$${G}_{V} = [ \begin{matrix}- T ( U ) \\ - {F}_{V} ( U , V ) \\ {C}_{U} ( t , U ) T ( U )\end{matrix} ] , \\ and$$

$${G}_{Λ} = [ - {( {C}_{U} ( t , U ) T ( U ) )}^{T} ]$$

$$where$$

$${C}_{t , U} = \frac{{\partial }^{2} C}{\partial t \partial U}$$

$$and$$

$${C}_{U , U} = \frac{{\partial }^{2} C}{\partial {U}^{2}} .$$

The Jacobian with regard to the time-derivative of the state is:

$${G}_{\dot{S}} = [ \begin{matrix}E & \\ & M ( U )\end{matrix} ]$$

And its time-derivative is:

$$\frac{d {G}_{\dot{S}}}{d t} = [ {M}_{U} ( U ) \dot{U} ]$$

where only the “center” element of the 3-by-3 block matrix is non-zero.

For the particular system discussed herein, g only depends on generalized positions and velocities:

g_{S}=[g_{U}g_{V}]

In summary, the linear adjoint DAE is:

$$[ \begin{matrix}E & \\ & {M}^{T}\end{matrix} ] \dot{λ} = ( - [ {\dot{U}}^{T} {M}_{U}^{T} ] + [ \begin{matrix}{G}_{U}^{T} \\ {G}_{V}^{T} \\ {G}_{Λ}^{T}\end{matrix} ] ) λ + [ \begin{matrix}{g}_{U}^{T} \\ {g}_{V}^{T}\end{matrix} ]$$

It remains to discuss initial conditions. To evaluate the gradient

$$\frac{dG}{d p} ,$$

one requires:

(λ^{T}G_{\dot{S}}Sₚ)|ₜ₌₀ and (λ^{T}G_{\dot{S}}Sₚ)|_{t=T}

At time t=0, the Jacobian Sₚ is equal to the analytical derivative

$$\frac{{dS}_{0}}{dp}$$

of the initial conditions S₀. If the initial conditions for the adjoint DAE are set to be λ(T)=0, then:

(λ^{T}G_{\dot{S}}Sₚ)|_{t=T}=0

Note that the initial conditions S₀ for the DAE are not dependent on p because the system is assumed to be at rest at the start of an animation. Hence, Sₚ is zero at time t=0, and, therefore:
(λ^{T} G_{\dot{S}}Sₚ)|ₜ₌₀=0

If objective g depends on the algebraic variables A, the initial conditions for the adjoint DAE, λ(T)=0, are in conflict with the adjoint DAE, and an additional treatment is necessary.

In summary, the analytical gradient of the objective is:

$$\frac{d G}{d p} = {\int }_{0}^{T} ( {g}_{p} - {λ}^{T} {G}_{p} ) d t$$

where the adjoint variables λ(T) are computed by solving the linear adjoint DAE:

$$[ \begin{matrix}E & \\ & {M}^{T}\end{matrix} ] \dot{λ} = ( - [ {\dot{U}}^{T} {M}_{U}^{T} ] + [ \begin{matrix}{G}_{U}^{T} \\ {G}_{V}^{T} \\ {G}_{Λ}^{T}\end{matrix} ] ) λ + [ \begin{matrix}{g}_{U}^{T} \\ {g}_{V}^{T}\end{matrix} ]$$

with initial conditions.

With the above vibration suppression systems and methods understood, it may now be useful to describe methods of providing dynamic balancing of robotic characters or systems (or simply “robots”). These methods may be implemented in a robot controller used to generate control signals for a robotic system such as by providing a new simulator and optimizer or modifying the ones described above to further include software or modules to provide dynamic balancing for retargeting motions onto the robotic systems.

It is expected that next-generation robotic or animatronic figures will be freely walking. For these robotic systems to be able to execute expressive performances without falling over, it will be important to provide enhanced control that include performing a retargeting of the animation (input to the controller or its simulator) onto these robotic characters that ensures that the resultant motion is dynamically balanced. Without such a dynamics-aware retargeting, the robotic characters would only be capable of slow and small movements without falling over.

Moreover, even for robotic systems that are anchored to the ground or a support (not free walking), it is of value to ask for a motion that preserves the artistic intent of the input animation for the system while making sure that the system is dynamically balanced. The benefits are at least two-fold. First, a dynamically balanced motion is, in general, perceived as more natural. If a robot would perform a motion that is physically not feasible, considering its proportions, mass distribution, and inertial effects, it is also most often perceived as less believable or natural. Second, a dynamically balanced motion requires less energy to perform and, therefore, leads to reduced motor torques. Hence, if one provides a controller with software to dynamically balance a motion, the robot can be controlled with control signals to execute motions with motors with lower torque limits.

The dynamic balancing method described herein works on arbitrary robot designs (or on a wide variety of differently designed robotic characters) including bipedal or quadrupedal systems or even fantasy characters with more than four feet. While the description is focused on contact of feet with the ground, the modeling provided can be used to model contact of hands or any other body part with the ground/environment. The dynamic balancing method may be thought of as an extension of the vibration suppression method(s) discussed above. Both control methods address a control problem (e.g., animation of a robotic system). By combining the dynamic balancing method with the motion retargeting objectives described to provide vibration suppression, a controller can be provided that can control very light and freely walking systems. For systems bolted or anchored to the ground, dynamic balancing can be used to reduce motor torques, and, therefore, the energy that is required to run a particular system. Motions that require less energy, in general, cause less vibrations. Therefore, one can expect that a controller that implements the dynamic balancing objectives described herein can further reduce vibrations.

The following description first provides a brief discussion of known concepts of balancing and then describes the simulator of a dynamic balancing controller by providing description of a useful simulation representation. Then, the description moves to a discussion of the dynamic balancing objectives, which may be used by the controller (or its optimizer) to generate control signals to operate motors/drivers within the robotic system to provide dynamic balancing.

Dynamic balancing requires the modeling of frictional contact. While concepts like the zero-moment point, discussed below, are familiar concepts to those skilled in the arts, the inventors formulation enables the dynamic balancing of flexible multi-body systems. It also enables the co-optimization of objectives that maximize balance but also minimize visible vibrations. The new dynamic balancing method taught herein provides a versatile solution not found in prior approaches or robotic control systems.

The simulation representation is similar to that discussed above with regard to vibration suppression, with its functions/steps carried out by the simulator of the controller in some cases. The robot includes a set of rigid and flexible bodies, with a proper two-way coupling. One important difference, though, with the vibration suppression approach is how feet are treated that are in contact with the ground at least for some frames of an input animation. In the dynamic balancing formulation, the foot pattern is assumed as known (or artist-specified). More specifically, it is assumed that is known when a rigid body is in contact with the ground and when it is not in contact. This information is relatively easy to extract from motion capture data or from an artist-specified input animation.

It may be useful to first discuss the control case where the robot is attached (e.g., bolted) to the ground. To keep these bodies fixed in space, the constraints of the form are enforced as:

C(c,q)=0

keeping the time-varying position c(t) and orientation q(t) of the respective rigid body fixed. As described above with regard to vibration suppression, quaternions q can be used to represent rotations.

For freely-walking robots, the feet can be treated as actuators to allow formulating constraints as:

$$( p , c , q , w ) = w [ \begin{matrix}c - ( {c}_{0} + {p}_{c} ) \\ {[ R ( q ) ]}_{x} \cdot {[ R ( {q}_{0} ) R ( {p}_{q} ) ]}_{y} \\ {[ R ( q ) ]}_{x} \cdot {[ R ( {q}_{0} ) R ( {p}_{q} ) ]}_{z} \\ {[ R ( q ) ]}_{y} \cdot {[ R ( {q}_{0} ) R ( {p}_{q} ) ]}_{z}\end{matrix} ] = 0 \qquad Eq . ( 30 )$$

where the 7 parameters

$$p ( t ) = [ \begin{matrix}{p}_{c} \\ {p}_{q}\end{matrix} ]$$

control the position (first three parameters) and orientation (last four parameters) of the rigid body and are set according to the input animation. Whenever the foot is in contact with the environment, the weight w(t) is set to a constant, non-zero value. If a foot is not in contact with the environment, the weight is set to zero to remove the constraints (while the system size remains the same). In the above constraint formulation, c₀ and g₀ are the initial position and orientation of the rigid body and are, therefore, not time-dependent. The [ ]_{{x,y,z}}-operator extracts the first, second, or third column of the rotation matrix R that we compute from the normalized quaternions, and the -operator represents the dot product.

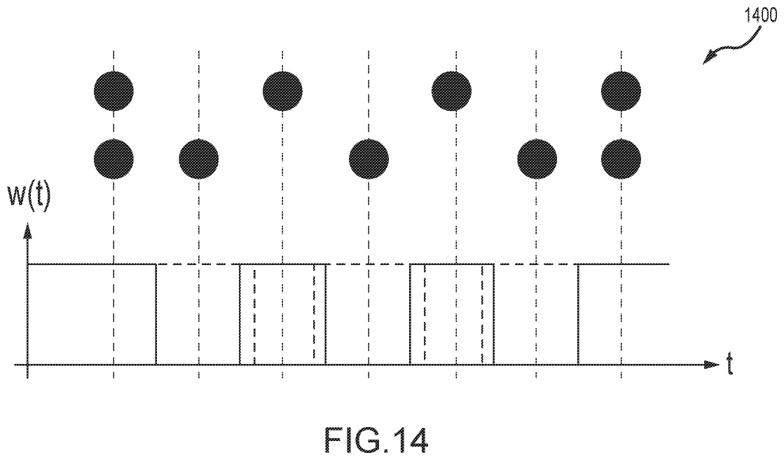

FIG. 14 illustrates with graph 1400 how the weights for a bipedal robot, for example, are set as part of the dynamic balancing simulation representation. For walking robots, the position and orientation of the rigid bodies are controlled with a time-varying parameter vector, p(t). Whenever a foot is not in contact with the ground, the corresponding weight is set to zero. This illustrated in graph 1400 for a bipedal system (left foot as the upper circles and solid line, and right foot as the lower circles and dashed line).

Turning now to optimization (and processing performed, in some cases, by the optimizer of the controller), it is useful to describe the dynamic balancing objectives, with an initial discussion of the interface with the vibration minimizing motion retargeting. With regard to parameterization and optimization, the same parameterization of actuated degrees of freedom (revolute and prismatic actuators or other actuators) as used for the vibration suppression can be used for dynamic balancing. The foot actuator parameters may be considered as optimization parameters in some cases, but the inventors chose to not consider them as such in the following optimization. Instead, the foot actuator parameters are set according to an input animation as described above. The weights that define pattern are also extracted from the user-specified input. The latter could be co-optimized to optimally alter the foot pattern in some useful implementations.

The dynamic balancing objectives complement the motion retargeting objectives as formulated above in the vibration suppression. The retargeting objectives include mechanisms to have rigid bodies follow a target position or orientation as closely as possible, and the dynamic balancing objectives can be chosen to help to further reduce vibrations.

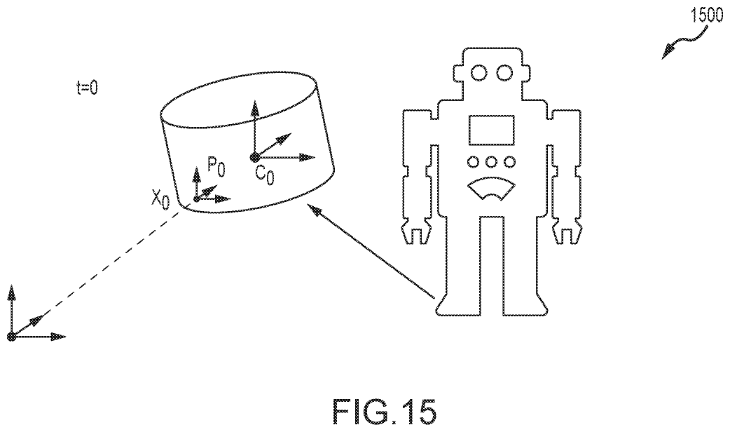

As an initial (and often repeated) step in controlling a robot with dynamic balancing, the robot may be balancing on a single foot. At time, t=0, or in the robot's rest configuration, a contact frame can be assumed to be specified, with the contact area being planar. While the x- and y-axes of the contact frame can point in arbitrary in-plane directions, the z-axis points in the direction of the plane normal, inwards (see or compare with FIG. 15). FIG. 15 illustrates a contact frame definition 1500. The global position of the frame origin is denoted with x₀ and the initial orientation is denoted with p₀. The contact frame is defined that is rigidly moving with the body of the robot, in the rest pose of the robot, where xo is the initial position and p₀ is the initial orientation of the frame in global coordinates.

When a simulation step is performed by the simulator of the controller, for example, the full state of the robot is solved for at time t. In particular, the state includes the position c and orientation q of the rigid body that represents the foot, and the Lagrange multipliers A that keep it in place. Note that the foot could also be bolted to the ground and not be actuated. While the set of constraints C are different in this case, the modeling interfaces with either case.

From the state quantities of the foot body, the forces and torques can be computed by the simulator that act from the ground onto the rigid body so that the body is kept in this particular state (if it is indeed in contact with the ground) with:

f=C_{c}^{T}λ and τ=(C_{q}½Q(q))^{T}λ Eq. (31)

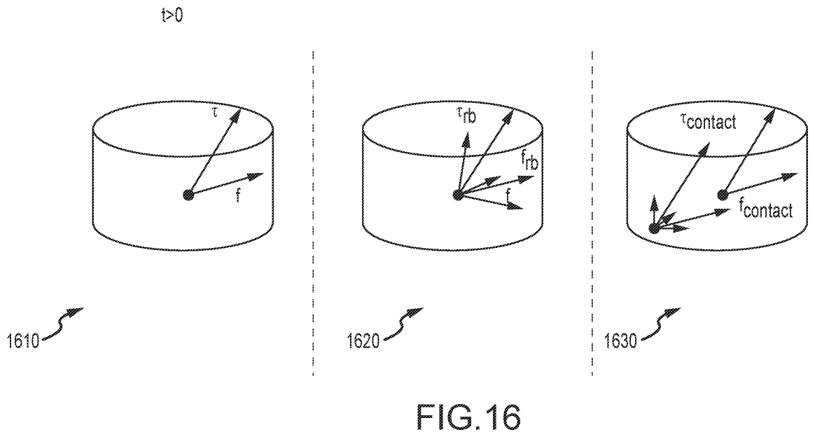

To be able to formulate objectives, these forces and torques are first transformed to the contact frame defined above (see also FIG. 16)

f_{contact}=R^{T}(p₀)R^{T}(q)f Eq. (32)

and

τ_{contact}=R^{T}(p₀)R^{T}(q)τ−R^{T}(p₀)(x₀−c₀)×f_{contact} Eq. (33)

With reference to FIG. 16, to be able to formulate dynamic balancing objectives, the forces and torques that act from the environment onto the rigid body are transformed into the local contact frame that is rigidly moving with it. As shown with graph 1610, the forces and torques are vectors in global coordinates, and the torque reference point is c. As shown in graph 1620, the inverse of the rigid body transformation is first applied to transform the vectors to rigid body coordinates (as shown by f_{rb}, τ_{rb}). As shown in graph 1630, in a final step, the forces and torques are transformed to the local contact frame, with the frame origin as the new reference for the torque.

In a next step, the so-called zero moment point is computed for the particular foot being looked at. To this end, the contact forces and torques are assumed to be 3-component vectors with entries:

$${f}_{contact} = [ \begin{matrix}{f}_{x} \\ {f}_{y} \\ {f}_{z}\end{matrix} ] and {τ}_{contact} = [ \begin{matrix}{τ}_{x} \\ {τ}_{y} \\ {τ}_{z}\end{matrix} ] \qquad Eq . ( 34 )$$

The optimizer (or optimization method) can then solve for the position of the zero-moment point (pₓ, p_{y}) in the plane spanned by the x- and y-axes of the local contact frame, and the moment about the z-axis m_{z}, by solving the three equations:

$$[ \begin{matrix}{τ}_{x} \\ {τ}_{y} \\ {τ}_{z}\end{matrix} ] = [ \begin{matrix}0 \\ 0 \\ {m}_{z}\end{matrix} ] + [ \begin{matrix}{p}_{x} \\ {p}_{y} \\ 0\end{matrix} ] \times [ \begin{matrix}{f}_{x} \\ {f}_{y} \\ {f}_{z}\end{matrix} ] \qquad Eq . ( 35 )$$

for the three unknowns.

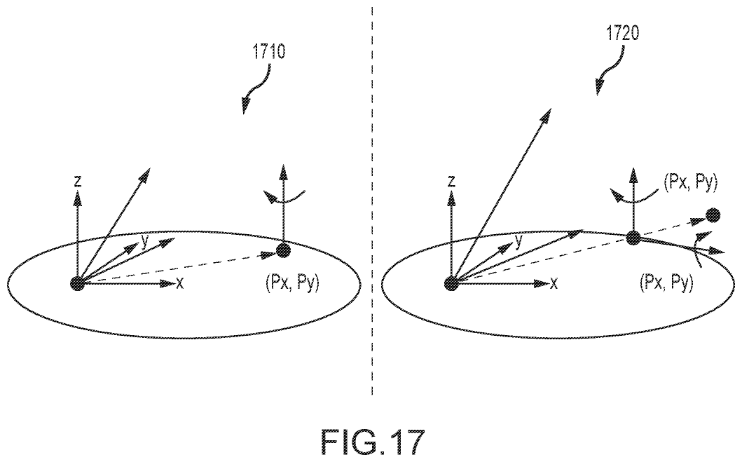

One important requirement for a robot to be dynamically balanced is that the zero-moment point, or the point at which the moments about the x- and y-axes are zero, is within the support of the respective foot. If this is not the case, there is a point on the foot boundary at which non-zero moments about the x- and y-axes are acting, which can result in the robot falling. FIG. 17 illustrates graphically, with graphs 1710 and 1720 zero-moment computations performed during optimization for to provide dynamic balancing (with dashed lines used to forces and dotted lines used to show torques/moments). To be able to formulate objectives for dynamic balancing, the zero-moment point (pₓ,p_{y}) is calculated, as shown in graph 1710, at which the moments about the x- and y-axes are zero. If the zero-moment point is outside of the support as shown in graph 1720, there is a point on the boundary where the moment about the x- and y-axes are non-zero, resulting in the robot falling. If the zero-moment lies inside the support, the character balances on the foot as shown in graph 1710.

In summary, the elements for dynamically balancing a robot on a single foot include: (1) non-negativity of the normal force, f_{z}≥0; (2) the force lies in the friction cone,

$$\frac{\sqrt{{f}_{x} {f}_{x} + {f}_{y} {f}_{y}}}{{f}_{z}} \leq μ ;$$

(3) the moment about the z-axis is bounded from above and below, m_{low}≤m_{z}≤mᵤₚ; and (4) the zero-moment point lies in the support of the foot, (pₓ,p_{y})∈S where S is the support area.

Rather than formulating constraints, the inventors formulated objectives that keep the forces and moments, and the zero-moment point, a safe distance away from the boundary. This can be achieved with barrier functions that become active if a small distance away from, for example, the support boundary. To bound a quantity from above, a barrier function can be used of the form:

$$a ( x ; t , ɛ ) = \{ \begin{matrix}- {ln}^{3} ( \frac{t - x}{ɛ} ) & x \geq t - ɛ \\ 0 & x < t - ɛ\end{matrix} \qquad Eq . ( 36 )$$

To form an objective, the to-be-bound quantity is substituted for x, the constant threshold for t (not the same quantity as time t), and a safety margin for ε. For example, for the moment bound m_{z}≤mᵤₚ, a(m_{z}; mᵤₚ, ε) is added to the set of objectives. The barrier function becomes active if the substituted quantity takes on values that are larger than t−ε. Note that this function is twice differentiable at t.

Analogously, the following barrier function can be used:

$$b ( x ; t , ɛ ) = \{ \begin{matrix}- {In}^{3} ( \frac{t - x}{ɛ} ) & x \leq t + ɛ \\ 0 & x > t + ɛ\end{matrix} \qquad Eq . ( 37 )$$

to bound quantities from below. For example, for the lower bound of the moment m_{z}, b(m_{z}; m_{low}, ε) can be added to the objectives.

In controlling a robot with dynamic balancing, it can be desirable to balance the robot on multiple feet. If not only a single but several feet are in contact with the ground, the fourth constraints, namely (pₓ, p_{y})∈S, can be replaced for all feet, with a single zero-moment point constraint for the combined forces and torques that act from the ground onto the character. The support S for this combined objective is set to the convex hull of the individual supports. To compute the combined forces and torques, the contact frame of one of the feet can be chosen as the reference frame, transforming the forces and torques that act on all other feet to this reference frame. Hereafter, the transformations are explained for a foot pair (A, B), where A is chosen as the reference frame.

After a simulation is run, the forces and torques can be elevated for both feet as:

f^{A},τ^{A}and f^{B},τ^{B} Eq. (38)

To transform the forces and torques that act on A to the contact frame of A, one can proceed as above (Eqs. 32 and 33). Before the forces and torques can be added, the generalized forces that act on B to are transformed to the contact frame of B:

f_{contact}^{B}=R^{T}(p₀^{A})R^{T}(q^{A})f^{B} Eq. (39)

and

τ_{contact}^{B}=R^{T}(p₀^{A})R^{T}(q^{A})τ^{B}−(R^{T}(p₀^{A})(x₀^{A}−c₀^{B}))×f_{contact}^{B} Eq. (40)

All the contact forces are then added to form the combined forces f_{contact} and τ_{contact}, and then, as in the single foot case, one can proceed with setting S to the convex hull of the individual supports.

As part of optimization, to keep the number of objectives constant and to switch off objectives that are not active, objectives can be multiplied with the foot pattern weights w(t) for the individual feet. The combined foot objective only accounts for feet for which the weights are non-zero. If a foot is not in contact with the ground, the constraints that keep it at the user-specified location, are removed from the simulation system. The balancing objectives are also inactive, which means that the foot can freely move. To ‘guide’ the motion, additional retargeting objectives can be added that keep it close to a user-specified position and orientation trajectory, controlling the transition to the in-contact state by increasing their weights.

We claim:

1. A system for providing dynamic balancing in a robotic system, comprising:
memory storing a definition of a robot defining a plurality of components of the robot and storing an input animation for the robot specifying motion of the components of the robot over a time period;
a processor communicatively linked to the memory;
a simulator provided by the processor running software, wherein the simulator performs a dynamic simulation of the robot performing the input animation including modeling a first set of the components as flexible components and a second set of the components as rigid components, wherein each of the flexible components is coupled at opposite ends to one of the rigid components; and
an optimizer provided by the processor running software, wherein the optimizer generates a retargeted motion for the components to provide dynamic balancing of the robot while performing the retargeted motion.

2. The system of claim 1, wherein the optimizer generates the retargeted motion, in part, by transforming forces and torques acting from an environment in which the robot is positioned onto the robot to a local contact frame rigidly moving with the robot.

3. The system of claim 1, wherein the optimizer generates the retargeted motion such that a zero-moment point of the robot lies in a support area of one or more feet or other effector components of the robot contacting an environmental surface.

4. The system of claim 3, wherein the optimizer generates the retargeted motion such that the normal force on the one or more feet or other effector components is non-negative.

5. The system of claim 3, wherein the optimizer generates the retargeted motion such that forces applied to the robot from the environmental surface lie in a friction cone.

6. The system of claim 3, wherein the optimizer generates the retargeted motion such that a moment about the vertical axis of one or more feet or other effector components is bounded from above and below.

7. The system of claim 3, wherein the optimizer generates the retargeted motion using objectives formulated to retain the zero-moment point a minimum distance from a boundary of the support area.

8. The system of claim 1, wherein the ends of the flexible components are coupled to the rigid components using constraint-based, two-way coupling.

9. The system of claim 1, wherein the optimizer generates the retargeted motion by adjusting the defined motion to suppress a portion of the vibrations and wherein the portion of the vibrations that is suppressed comprises low-frequency, large-amplitude vibrations of one or more of the components of the robot.

10. The system of claim 1, wherein the components include marker points and wherein the generating of the retargeted motion comprises retaining orientations of the marker points as defined in the specified motion of the input animation and wherein the generating of the retargeted motion includes retaining positions of tracked marker points or a tracked set of the rigid components in global coordinates relative to the input animation.

11. The system of claim 1, further comprising a robot controller including the processor and wherein the robot controller generates a set of control signals for a physical implementation of the robot based on the retargeted motion generated by the optimizer.

12. A system for controlling a robotic system with dynamic balancing, comprising:
memory storing parameters of a target robotic system and an input motion for the target robotic system, wherein the input motion is defined by a set of motor trajectories defining movement of components of the robotic system; and
an optimizer modifying the set of motor trajectories to provide dynamic balancing of the robotic system during operations to perform a retargeted motion based on the input motion.

13. The system of claim 12, wherein the modifying comprises transforming forces and torques acting on the robot to a local contact frame rigidly moving with the robot.

14. The system of claim 13, wherein the modifying comprises generating the retargeted motion such that the transformed forces lie in a friction cone.

15. The system of claim 12, wherein the modifying comprises generating the retargeted motion such that a zero-moment point of the robot lies in a support area of one or more feet or other effector components of the robot contacting the ground or a support surface.

16. The system of claim 15, wherein the modifying comprises generating the retargeted motion such that the normal force on the one or more feet or other effector components is non-negative and a moment about the vertical axis of the one or more feet or other effector components is bounded from above and below.

17. The system of claim 12, further comprising a differential dynamics simulator generating a simulation of the input motion by modeling the target robotic system by representing flexible parts of the components with deformable bodies and stiff parts of the components with rigid bodies and by enforcing two-way coupling constraints between ends of the deformable bodies coupled to the rigid bodies.

18. The system of claim 17, wherein the simulation includes enforcing mechanical constraints between coupled pairs of the rigid bodies and wherein the enforcing of the mechanical constraints and the two-coupling constraints is performed using a unified constrained dynamics model.

19. A method of suppressing vibration in a robotic system, comprising:
receiving a set of input motions for a robot;
simulating the robot operating based on the set of input motions by representing, during replaying of the set of input motions, flexible components of the robot as deformable bodies and rigid components of the robot as rigid bodies and by enforcing two-way coupling constraints between ends of the deformable bodies and the rigid bodies; and
optimizing the set of input motions to generate a retargeted motion for the components of the robot that provides dynamic balancing of the robot, wherein the optimizing comprises computing the retargeted motion to provide a zero-moment point of the robot that lies in a support area of one or more feet or other effector components of the robot during the simulating.

20. The method of claim 19, wherein the optimizing comprises computing the retargeted motion by transforming forces and torques acting from an environment in which the robot is positioned onto the robot to a local contact frame rigidly moving with the robot, by requiring that the normal force on the one or more feet or other effector components is non-negative, by requiring that the transformed forces lie in a friction cone, and by requiring that a moment about the vertical axis of the one or more feet or other effector components is bounded from above and below.

21. The method of claim 19, wherein the optimizing comprises optimizing the set of input motions to generate the retargeted motion for the components of the robot that suppresses the low-frequency vibrations, comparing differences between trajectories for a set of user-selected points on the rigid components during the replaying of the set of input motions and target trajectories for the set of user-selected points defined by the set of input motions, and optimizing, based on the comparing, motion profiles of motors of the robot to reduce visible vibrations in the robot.
